(19) United States
(12) Patent Application Publication
(10) Pub. No.: US 2026/0296720 A1
(43) Pub. Date: Oct. 1, 2026

(54) IMPROVED CONTAINER ASSEMBLY FOR AGING LIQUID

(71) Applicant: BIT365, San Francisco, CA (US)

(72) Inventor: Jonathan William Roleder, St. Helena, CA (US)

(21) Appl. No.: 19/479,915

(22) PCT Filed: Aug. 28, 2023
(86) PCT No.: PCT/US2023/073023

§ 371 Date: Oct. 29, 2025

Related U.S. Application Data
(60) Provisional application No. 63/467,912, filed on May 19, 2023.

(51) Int. Cl. B65D 8/00; C12H 1/22

(52) U.S. Cl. CPC B65D 7/045; C12H 1/22

(57) ABSTRACT

A container assembly (10) for retaining a liquid (13) during aging of the liquid (13) is configured to selectively receive and retain a flavor insert (18) that is configured to impart a flavor on the liquid (13). The container assembly (10) includes a container body (12), an insert retainer assembly (16), and a key lock (970). The container body (12) defines a chamber (12A) which is configured to receive and retain the liquid (13). The insert retainer assembly (16) is positioned within the chamber (12A). The insert retainer assembly (16) is rotatably coupled to the container body (12). The insert retainer assembly (16) includes an insert retainer (748) that is configured to receive and retain the flavor insert (18). The key lock (970) is selectively coupled to the insert retainer assembly (16) to inhibit relative rotation between the insert retainer assembly (16) and the container body (12).

### RELATED APPLICATION

This Application is related to and claims priority on U.S. Provisional Patent Application Ser. No. 63/467,912 filed on May 19 2023, and entitled “IMPROVED CONTAINER ASSEMBLY FOR AGING A LIQUID”. As far as permitted, the contents of U.S. Provisional Patent Application Ser. No. 63/467,912 are incorporated in their entirety herein by reference.

### BACKGROUND

Wood barrels are commonly used to age wine and other beverages. Unfortunately, wood barrels are relatively expensive to make and have a relatively short operational life. For example, a high-end wood barrel used for only the finest wines is typically made from French oak and is very expensive. Additionally, the chemical ability of the wood to effect and impart flavor nuances expires rapidly and a wood barrel can typically only be considered to be in its prime for two to three years, or one to two vintages. Once a traditional wood barrel has exhausted its chemical ability to impart flavors on the liquid, i.e. has gone “oak neutral”, the conventional barrel is often sold on the used market or committed to lesser quality beverages. This creates a rapidly depreciating asset and investment for the beverage maker.

Recently, more and more beverage makers have been switching to metal containers, made from materials such as stainless steel, which impart no flavor on the beverage, for aging their beverages. There is a constant desire to improve the containers that are used for aging a liquid in beverage manufacturing.

### SUMMARY

The present invention is directed toward a container assembly for retaining a liquid during aging of the liquid. The container assembly is configured to selectively receive and retain a flavor insert that is configured to impart a flavor on the liquid. In various embodiments, the container assembly includes a container body, an insert retainer assembly, and a key lock. The container body defines a chamber which is configured to receive and retain the liquid. The insert retainer assembly is positioned within the chamber. The insert retainer assembly is rotatably coupled to the container body. The insert retainer assembly includes an insert retainer that is configured to receive and retain the flavor insert. The key lock is selectively coupled to the insert retainer assembly to inhibit relative rotation between the insert retainer assembly and the container body.

In certain embodiments, the insert retainer assembly further includes a connector assembly that rotatably couples the insert retainer assembly to the container body. The connector assembly includes a proximal end. The key lock selectively engages the proximal end of the connector assembly in order to inhibit relative rotation between the insert retainer assembly and the container body.

In some embodiments, the key lock is movable relative to the proximal end of the connector assembly between (i) a fully seated configuration, where the key lock engages the proximal end of the connector assembly to inhibit relative rotation between the insert retainer assembly and the container body, and (ii) a partially seated configuration, where the key lock engages the proximal end of the connector assembly but does not inhibit relative rotation between the insert retainer assembly and the container body.

In certain embodiments, the proximal end of the connector assembly includes a first engagement feature that is configured to engage a portion of a lock distal end of the key lock so that the lock distal end fits over the proximal end of the connector assembly in only one specific rotational orientation.

In some embodiments, the first engagement feature is a radially outward-facing projection that is configured to engage a portion of the lock distal end of the key lock so that the lock distal end fits over the proximal end of the connector assembly in only one specific rotational orientation.

In certain embodiments, the lock distal end of the key lock includes a second engagement feature that is configured to engage the first engagement feature formed onto the proximal end of the connector assembly so that the lock distal end fits over the proximal end of the connector assembly in only one specific rotational orientation.

In some embodiments, the second engagement feature is a radially inward-facing slot that is configured to engage the radially outward-facing projection formed onto the proximal end of the connector assembly so that the lock distal end fits over the proximal end of the connector assembly in only one specific rotational orientation.

In certain embodiments, the container assembly further includes a rotator that is selectively coupled to the key lock, the rotator including a rotator distal end. In some embodiments, a lock proximal end of the key lock includes a rotator engager that is configured to engage a portion of the rotator distal end of the rotator so that the rotator distal end fits over the lock proximal end of the key lock in only one specific rotational orientation.

In certain embodiments, the rotator engager is a radially outward-facing projection on the lock proximal end of the key lock that is configured to engage a portion of the rotator distal end of the rotator so that the rotator distal end fits over the lock proximal end of the key lock in only one specific rotational orientation.

In some embodiments, the container assembly further includes an upper mount that is fixedly coupled to the container body, the upper mount including a mount aperture. In certain embodiments, the proximal end of the connector assembly is configured to extend at least partially through the mount aperture.

In some embodiments, the upper mount includes a mount proximal end that extends outwardly away from the container body.

In certain embodiments, the key lock is movable between (i) a fully seated configuration, where the key lock engages the proximal end of the connector assembly and further engages the mount proximal end of the upper mount, so that the key lock and the insert retainer assembly rotate together with one another, and where relative rotation is inhibited between the insert retainer assembly and the container body, (ii) a partially seated configuration, where the key lock engages the proximal end of the connector assembly, but does not engage the mount proximal end of the upper mount, so that the key lock and the insert retainer assembly rotate together with one another, but where relative rotation is permitted between the insert retainer assembly and the container body, and (iii) an unseated configuration, where the key lock does not engage the proximal end of the connector assembly and does not engage the mount proximal end of the upper mount.

In some embodiments, the container assembly further includes a seating adjustment system including a first seating adjustment member that is coupled to a lock distal end of the key lock and a second seating adjustment member that is coupled to the mount proximal end of the upper mount. The first seating adjustment member engages the second seating adjustment member when the key lock is in the fully seated configuration; and the first seating adjustment member does not engage the second seating adjustment member when the key lock is in the partially seated configuration.

In certain embodiments, the first seating adjustment member includes a radially outward-facing projection that is coupled to the lock distal end of the key lock; and wherein the second seating adjustment member is a slot that is formed into the mount proximal end of the upper mount.

In some embodiments, the seating adjustment system includes two first seating adjustment members that are coupled to the lock distal end of the key lock and two second seating adjustment members that are coupled to the mount proximal end of the upper mount.

In certain embodiments, the two first seating adjustment members are spaced apart approximately 180 degrees from one another about the lock distal end of the key lock; and the two second seating adjustment members are spaced apart approximately 180 degrees from one another about the mount proximal end of the upper mount.

In some embodiments, the insert retainer assembly further includes a retainer base, the insert retainer being coupled to the retainer base, the insert retainer including at least a first engagement region that is positioned at a first height relative to the retainer base, and a second engagement region that is positioned at a second height relative to the retainer base that is different than the first height. In certain embodiments, the insert retainer is configured to receive and retain a distal end of the first flavor insert substantially adjacent to the first engagement region; and the insert retainer is configured to receive and retain a distal end of the second flavor insert substantially adjacent to the second engagement region.

In some embodiments, the insert retainer is configured to frictionally engage the distal end of the first flavor insert substantially adjacent to the first engagement region; and the insert retainer is configured to frictionally engage the second flavor insert substantially adjacent to the second engagement region.

In certain embodiments, the insert retainer includes a first retainer member and a second retainer member that are both coupled to the retainer base, the retainer members being spaced apart from one another to define the first engagement region and the second engagement region.

In some embodiments, at least one of the first retainer member and the second retainer member includes a plurality of “S”-shaped curves to define the first engagement region and the second engagement region.

In other embodiments, each of the first retainer member and the second retainer member includes a plurality of “S”-shaped curves to define the first engagement region and the second engagement region.

In certain embodiments, the first retainer member and the second retainer member are flexibly coupled to the retainer base.

In some embodiments, the insert retainer moves to a deflected position relative to the retainer base when the insert retainer receives and retains the distal end of the first flavor insert substantially adjacent to the first engagement region.

In certain embodiments, the first engagement region defines a first deflected spacing that is equal to a first thickness of the first flavor insert when the insert retainer receives and retains the distal end of the first flavor insert substantially adjacent to the first engagement region.

In some embodiments, the insert retainer moves to a deflected position relative to the retainer base when the insert retainer receives and retains the distal end of the second flavor insert substantially adjacent to the second engagement region.

In certain embodiments, the second engagement region defines a second deflected spacing that is equal to a second thickness of the second flavor insert when the insert retainer receives and retains the distal end of the second flavor insert substantially adjacent to the second engagement region.

In some embodiments, the insert retainer further includes a third engagement region that is positioned at a third height relative to the retainer base that is different than the first height and the second height; and wherein the insert retainer is configured to receive and retain a distal end of a third flavor insert substantially adjacent to the third engagement region, the third flavor insert being configured to impart a third flavor on the liquid, the third flavor insert having a third insert thickness that is different than the first insert thickness and the second insert thickness.

In certain embodiments, the insert retainer is configured to frictionally engage the distal end of the third flavor insert substantially adjacent to the third engagement region.

In some embodiments, the container assembly further includes a temperature controller that is configured to regulate a temperature of the liquid that is retained within the chamber, the temperature controller including a fluid source that supplies a fluid, and a fluid circulating band that is positioned adjacent to the container body, the fluid circulating band being in fluid communication with the fluid source so that the fluid from the fluid source circulates through the fluid circulating band.

In certain embodiments, the fluid circulating band is positioned to substantially encircle the container body.

In some embodiments, the fluid circulating band includes a band body which defines at least a portion of a fluid chamber substantially adjacent to a surface of the container body, a fluid inlet through which the fluid from the fluid source is directed into the fluid chamber, and a fluid outlet through which the fluid from the fluid source is directed out of the fluid chamber.

In certain embodiments, the band body has a substantially “C”-shaped cross-section.

In some embodiments, the temperature controller further includes a temperature regulator that regulates a temperature of the fluid at the fluid source.

In certain embodiments, the fluid is glycol.

In some embodiments, the container body includes a top having an insert opening that extends through the top. In certain embodiments, the container assembly further includes a cover door assembly that is configured to selectively cover the insert opening, the cover door assembly including (i) a cover door that is movable relative to the insert opening between a closed configuration where the cover door covers the insert opening and an open configuration where the cover door does not cover the insert opening, (ii) a door support arm that is coupled to the cover door, and (iii) a door adjustment screw that adjustably couples the door support arm to the cover door; wherein the door adjustment screw is coupled to the cover door when the cover door is in both the closed configuration and the open configuration.

In some embodiments, when the cover door is in the closed configuration, the cover door seals the insert opening.

In certain embodiments, the cover door assembly further includes a seal that is positioned substantially between the cover door and the top of the container body to seal the insert opening when the cover door is in the closed configuration.

In some embodiments, movement of the door adjustment screw enables the cover door to move relative to the insert opening between the closed configuration and the open configuration.

In certain embodiments, the cover door includes a door aperture and the door support arm includes an arm aperture; and the door adjustment screw is configured to extend fully through the arm aperture and at least partially through the door aperture.

In some embodiments, the door adjustment screw extends at least partially through the door aperture when the cover door is in both the closed configuration and the open configuration.

In certain embodiments, the cover door assembly further includes a disengagement inhibitor that inhibits the door adjustment screw from being removed from the door aperture.

The present invention is further directed toward a container assembly for retaining a liquid during aging of the liquid, the container assembly being configured to selectively receive and retain a first flavor insert that is configured to impart a first flavor on the liquid and a second flavor insert that is configured to impart a second flavor on the liquid, the first flavor insert having a first insert thickness and the second flavor insert having a second insert thickness that is different than the first insert thickness, including a container body that defines a chamber which is configured to receive and retain the liquid; and an insert retainer assembly that is positioned within the chamber, the insert retainer assembly being coupled to the container body, the insert retainer assembly including a retainer base and an insert retainer that is coupled to the retainer base, the insert retainer including at least a first engagement region that is positioned at a first height relative to the retainer base, and a second engagement region that is positioned at a second height relative to the retainer base that is different than the first height; wherein the insert retainer is configured to receive and retain a distal end of the first flavor insert substantially adjacent to the first engagement region; and wherein the insert retainer is configured to receive and retain a distal end of the second flavor insert substantially adjacent to the second engagement region.

The present invention is also directed toward a container assembly for retaining a liquid during aging of the liquid, the container assembly being configured to selectively receive and retain a first flavor insert that is configured to impart a first flavor on the liquid and a second flavor insert that is configured to impart a second flavor on the liquid, the first flavor insert having a first insert thickness and the second flavor insert having a second insert thickness that is different than the first insert thickness, including a container body that defines a chamber which is configured to receive and retain the liquid; and an insert retainer assembly that is positioned within the chamber, the insert retainer assembly being coupled to the container body, the insert retainer assembly including a retainer base and an insert retainer that is coupled to the retainer base, the insert retainer including at least a first engagement region that is configured to receive and retain a distal end of the first flavor insert, but that does not receive and retain the second flavor insert; and (ii) a second engagement region that is configured to receive and retain a distal end of the second flavor insert, but that does not receive and retain the first flavor insert.

The present invention is further directed toward a container assembly for retaining a liquid during aging of the liquid, including a container body that defines a chamber which is configured to receive and retain the liquid; and a temperature controller that is configured to regulate a temperature of the liquid that is retained within the chamber, the temperature controller including a fluid source that supplies a fluid, and a fluid circulating band that is positioned adjacent to the container body, the fluid circulating band being in fluid communication with the fluid source so that the fluid from the fluid source circulates through the fluid circulating band.

The present invention is also directed toward a container assembly for retaining a liquid during aging of the liquid, the container assembly being configured to selectively receive and retain a flavor insert that is configured to impart a flavor on the liquid, including a container body that defines a chamber which is configured to receive and retain the liquid, the container body including a top having an insert opening that extends through the top; an insert retainer assembly positioned within the chamber, the insert retainer assembly being coupled to the container body, the insert retainer assembly including an insert retainer that is configured to receive and retain the flavor insert; and a cover door assembly that is configured to selectively cover the insert opening, the cover door assembly including (i) a cover door that is movable relative to the insert opening between a closed configuration where the cover door covers the insert opening and an open configuration where the cover door does not cover the insert opening, (ii) a door support arm that is coupled to the cover door, and (iii) a door adjustment screw that adjustably couples the door support arm to the cover door; wherein the door adjustment screw is coupled to the cover door when the cover door is in both the closed configuration and the open configuration.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a partially exploded, top perspective view illustration of a portion of an embodiment of a container assembly having features of the present invention;

FIG. 1B is a partially exploded, top perspective view illustration of a portion of the container assembly illustrated in FIG. 1A;

FIG. 1C is a perspective view illustration of a portion of the container assembly illustrated in FIG. 1A, including certain additional components not otherwise shown in FIG. 1A;

FIG. 2A is a simplified side view illustration of a portion of the container assembly illustrated in FIG. 1A, the container assembly including a liquid temperature control system having features of the present invention;

FIG. 2B is a simplified sectional view illustration of the container assembly cut on line 2B-2B in FIG. 2A;

FIG. 3A is a simplified perspective view illustration of an embodiment of a fluid circulating band that can be included as part of the liquid temperature control system;

FIG. 3B is a simplified top view illustration of the fluid circulating band illustrated in FIG. 3A;

FIG. 3C is a simplified side view illustration of the fluid circulating band illustrated in FIG. 4A;

FIG. 4A is a simplified top view illustration of a portion of the container assembly illustrated in FIG. 1A;

FIG. 4B is a simplified top perspective view illustration of the portion of the container assembly illustrated in FIG. 4A, including an embodiment of the liquid temperature control system;

FIG. 4C is a simplified top perspective view illustration of the portion of the container assembly illustrated in FIG. 4A, including another embodiment of the liquid temperature control system;

FIG. 4D is a simplified top perspective view illustration of the portion of the container assembly illustrated in FIG. 4A, including still another embodiment of the liquid temperature control system;

FIG. 5A is another simplified side view illustration of a portion of the container assembly illustrated in FIG. 1A;

FIG. 5B is a simplified sectional view illustration of the container assembly cut on line 5B-5B in FIG. 5A, the container assembly including an embodiment of an insert retainer assembly having features of the present invention;

FIG. 6A is a simplified partially exploded perspective view illustration of an embodiment of a retainer rack having features of the present invention that can be included as part of the insert retainer assembly;

FIG. 6B is a simplified top view illustration of the retainer rack illustrated in FIG. 6A;

FIG. 6C is a simplified side view illustration of the retainer rack illustrated in FIG. 6A;

FIG. 7 is a simplified schematic side view illustration of an embodiment of an insert retainer having features of the present invention that can be included as part of the insert retainer assembly, and a plurality of flavor inserts that can be selectively received and retained with the insert retainer;

FIG. 8A is a simplified perspective view illustration of a portion of the insert retainer illustrated in FIG. 7;

FIG. 8B is a simplified side view illustration of the portion of the insert retainer illustrated in FIG. 8A;

FIG. 9A is a simplified partially exploded cutaway side view illustration of a portion of a key lock assembly having features of the present invention that can be included as part of the container assembly, the key lock assembly including a key lock and a proximal end of a connector assembly, the key lock being shown in a fully seated configuration relative to the proximal end of the connector assembly;

FIG. 9B is an exploded cutaway side view illustration of a portion of the key lock assembly illustrated in FIG. 9A, the key lock being shown in an unseated configuration relative to the proximal end of the connector assembly;

FIG. 10A is a simplified perspective view illustration of a portion of an embodiment of a connector assembly that can be included as part of the key lock assembly illustrated in FIG. 9A;

FIG. 10B is a simplified top view illustration of the portion of the connector assembly illustrated in FIG. 10A;

FIG. 10C is a simplified bottom view illustration of the portion of the connector assembly illustrated in FIG. 10A;

FIG. 10D is a simplified side view illustration of the portion of the connector assembly illustrated in FIG. 10A;

FIG. 10E is a simplified sectional view illustration of the portion of the connector assembly taken on line 10E-10E in FIG. 10D;

FIG. 11A is a simplified perspective view illustration of an embodiment of a key lock that can be included as part of the key lock assembly illustrated in FIG. 9A;

FIG. 11B is a simplified top view illustration of the key lock illustrated in FIG. 11A;

FIG. 11C is a simplified bottom view illustration of the key lock illustrated in FIG. 11A;

FIG. 11D is a simplified side view illustration of the key lock illustrated in FIG. 11A;

FIG. 11E is a simplified sectional view illustration of the key lock taken on line 11E-11E in FIG. 11D;

FIG. 12A is a simplified perspective view illustration of an embodiment of an upper mount that can be included as part of the key lock assembly illustrated in FIG. 9A;

FIG. 12B is a simplified top view illustration of the upper mount illustrated in FIG. 12A;

FIG. 12C is a simplified bottom view illustration of the upper mount illustrated in FIG. 12A;

FIG. 12D is a simplified side view illustration of the upper mount illustrated in FIG. 12A;

FIG. 12E is a simplified sectional view illustration of the upper mount taken on line 12E-12E in FIG. 12D;

FIG. 13A is a perspective view illustration of a portion of the container assembly illustrated in FIG. 1A, including the key lock and the upper mount, the key lock being shown in a partially seated configuration relative to a mount proximal end of the upper mount;

FIG. 13B is another perspective view illustration of the portion of the container assembly illustrated in FIG. 13A, with the key lock being rotated relative to the mount proximal end of the upper mount so that the key lock can be moved between the partially seated configuration and the fully seated configuration;

FIG. 14A is a simplified perspective view illustration of a portion of an embodiment of a cover door assembly having features of the present invention that can be included as part of the container assembly;

FIG. 14B is a simplified top view illustration of the cover door assembly illustrated in FIG. 14A; and

FIG. 14C is a simplified sectional view illustration of the cover door assembly taken on line 14C-14C in FIG. 14B, and further including a portion of a top of the container assembly and a seal that can also be included as part of the cover door assembly.

While embodiments of the present invention are susceptible to various modifications and alternative forms, specifics thereof have been shown by way of example and drawings, and are described in detail herein. It is understood, however, that the scope herein is not limited to the particular embodiments described. On the contrary, the intention is to cover modifications, equivalents, and alternatives falling within the spirit and scope herein.

### DESCRIPTION

Embodiments of the present invention are described herein in the context of a container assembly for aging a liquid, the container assembly having enhanced features in comparison to other container assemblies currently on the market.

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same or similar nomenclature and/or reference indicators will be used throughout the drawings and the following detailed description to refer to the same or like parts.

In the interest of clarity, not all of the routine features of the implementations described herein are shown and described. It is appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

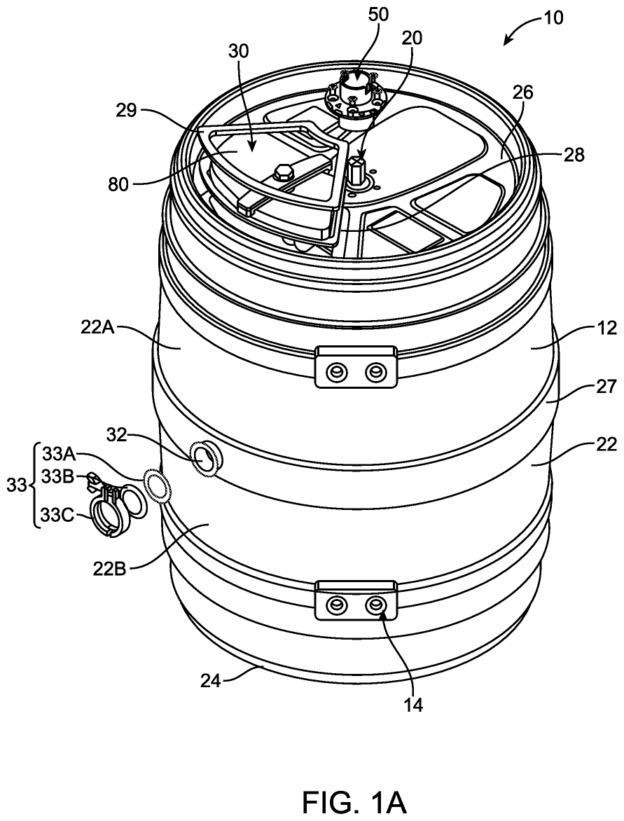

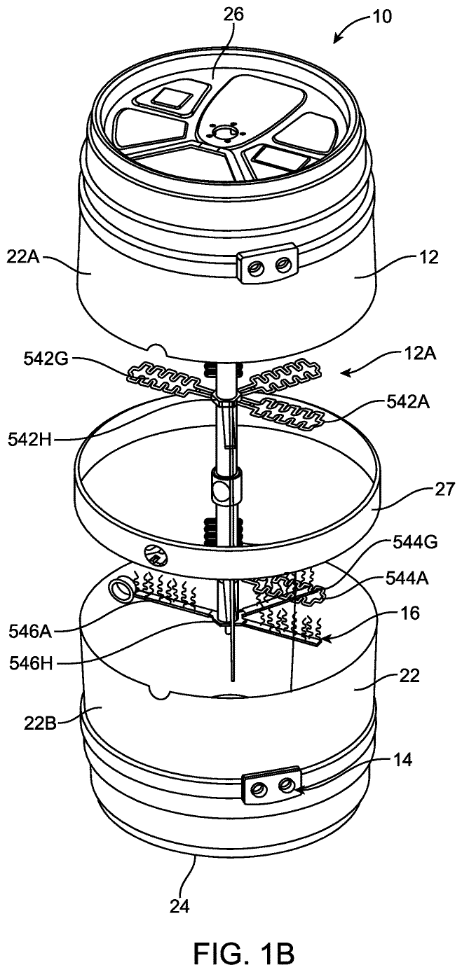

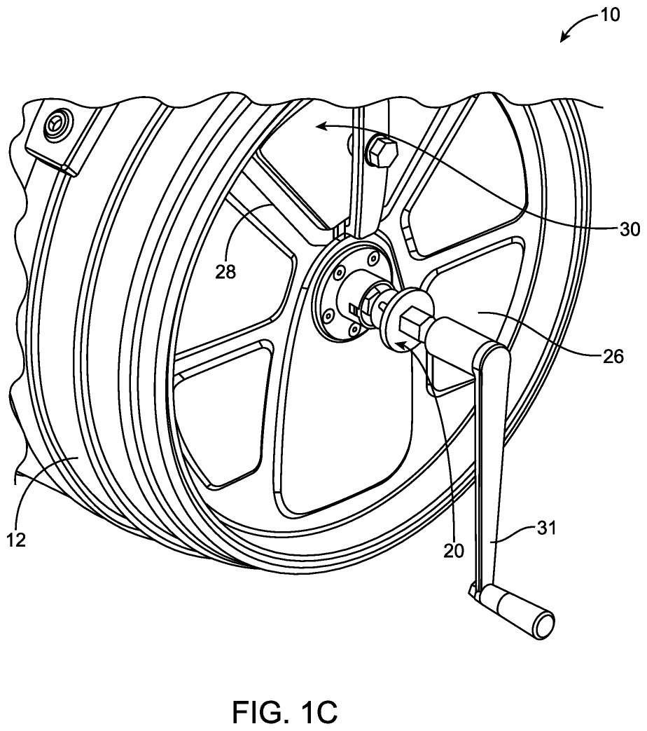

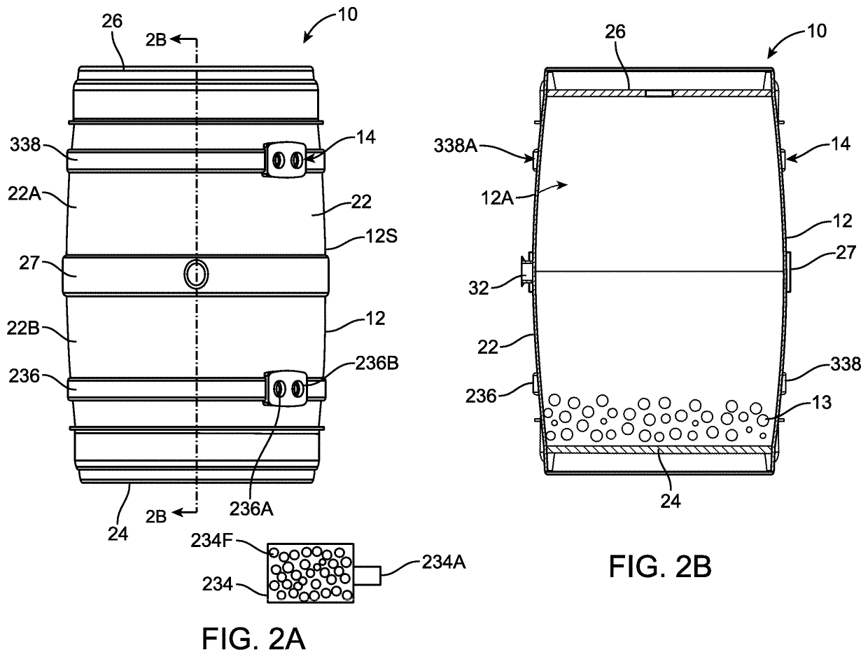

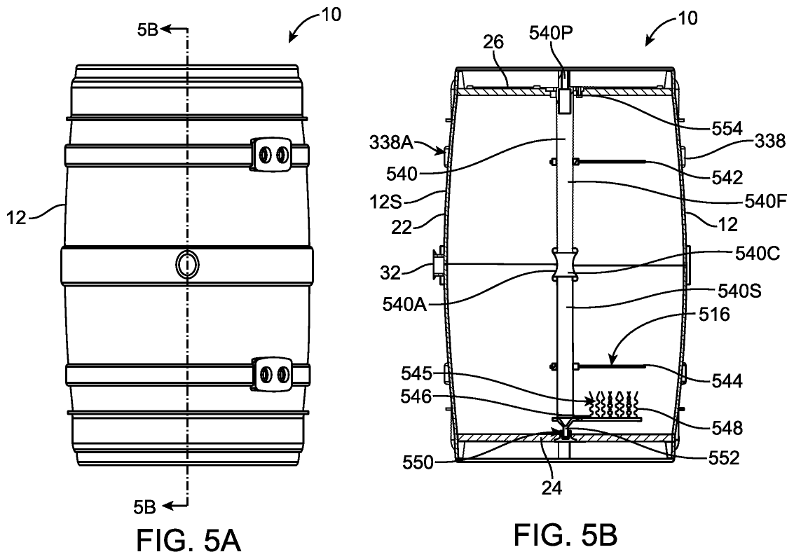

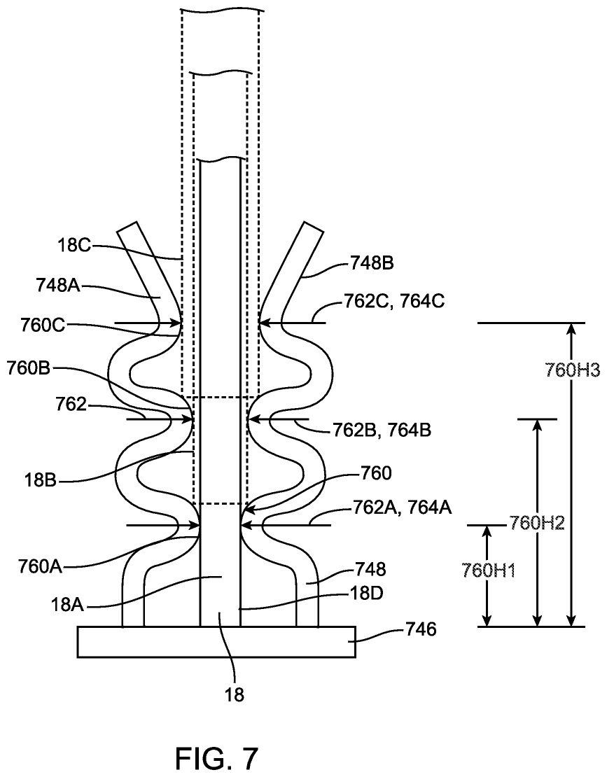

FIG. 1A is a partially exploded, top perspective view illustration of a portion of an embodiment of a container assembly 10 having features of the present invention. The size, shape, and number of components in the container assembly 10 can be varied to suit the design requirements of the container assembly 10. In various embodiments, the container assembly 10 includes one or more of (i) a container body 12 that is configured to retain a liquid 13 (illustrated as a plurality of circles in FIG. 2B) for aging, the container body 12 defining a chamber 12A (illustrated in FIG. 1B) therein that receives and retains the liquid 13 during the aging process, (ii) a liquid temperature control system 14 (also referred to herein as a “temperature controller”) that is coupled to the container body 12 and that is configured to control and/or regulate a temperature of the liquid 13 that is being aged within the container body 12, (iii) an insert retainer assembly 16 (illustrated in FIG. 1B) that is positioned substantially within the container body 12, the insert retainer assembly 16 being configured to retain a plurality of flavor inserts 18 (illustrated in FIG. 7) to impart flavor into the liquid 13 during the aging process, (iv) a key lock assembly 20 (only a portion is shown in FIG. 1A) that is configured to selectively inhibit relative rotation between the insert retainer assembly 16 and the container body 12, (v) a cover door assembly 30, and (vi) a mount assembly 50 that is configured to mount a connector assembly 540 (illustrated in FIG. 5B) and, thus, the insert retainer assembly 16 to the container body 12. Alternatively, the container assembly 10 can include more components or fewer components than what is illustrated and described herein without deviating from the intended breadth and scope of the present invention.

As an overview, the present invention provides various advantages over the container assemblies currently on the market. For example, in various embodiments, the key lock assembly 20, the insert retainer assembly 16, the temperature controller 14, and the cover door assembly 30 all have unique designs that provide distinct advantages in comparison to conventional container assemblies currently on the market.

In particular, the key lock assembly 20 is uniquely configured to selectively inhibit relative rotation between the insert retainer assembly 16 and the container body 12. When aging a liquid 13 within the container body 12, it is generally desired that the flavor inserts 18 be maintained in position within the liquid 13 in order to impart any desired flavors into the liquid 13, even in instances where the container body 12 is only partially filled with the liquid 13. However, with the container body 12 positioned on its side, as is typically done, the components of the insert retainer assembly 16 will typically be positioned, due to gravity, with the heavier portions facing in a generally downward direction into the liquid 13. The heavier components would typically include a paddle (not shown) that can be much heavier than the flavor inserts 18 and components of alignment racks 542, 544 (illustrated in FIG. 5B) and a retainer rack 545 (illustrated in FIG. 1B) that cooperate to retain the favor inserts 18. Thus, without the ability to control the positioning of the flavor inserts 18 and the components of the insert retainer assembly 16, the weight of the paddle can easily result in the flavor inserts 18 not being positioned within the liquid 13 as desired. Thus, as described herein, the ability to selectively inhibit relative rotation between the insert retainer assembly 16 (and thus the flavor inserts 18) and the container body 12 with the key lock assembly 20 enables the operator to ensure that the flavor inserts 18 are maintained in position within the liquid 13 during the aging process. Additionally, as further described herein, inhibiting relative rotation between the insert retainer assembly 16 and the container body 12 further enables the operator to obtain samples of the liquid 13 during the aging process due to the proper rotational position of a sampling aperture 540A (illustrated in FIG. 5B) that extends through a connector assembly 540 (illustrated in FIG. 5B), which couples the insert retainer assembly 16 to the container body 12.

Additionally, the insert retainer assembly 16 is uniquely configured to effectively receive and retain flavor inserts 18 of different thicknesses. Depending on the liquid 13 being aged within the container body 12, it is appreciated that different liquids 13 have different desired aging time frames. For example, it is recognized that certain liquids 13 are aged for longer periods of time and thus require larger (thicker) flavor inserts 18 in order to have the flavor inserts 18 continue to impart flavor into the liquid 13 during the aging process. As described in detail herein, the insert retainer assembly 16 includes insert retainers 748 (illustrated in FIG. 7) that are able to receive and retain (and frictionally engage) flavor inserts 18 of different thicknesses. Thus, the same container assembly 10 can be used for aging different liquids 13 for different periods of time without the need to change the insert retainer assembly 16 and/or the insert retainers 748 from one use to the next. Rather, the container assembly 10 merely needs to be cleaned before a subsequent use.

Further, the temperature controller 14 is uniquely configured to assist the operator in maintaining a desired temperature of the liquid 13 within the container body 12 during the aging process. In particular, as described in detail herein, the temperature controller 14 utilizes fluid circulating bands 236 (illustrated in FIG. 2A) that are positioned adjacent to the container body 12, the fluid circulating bands 236 being in fluid communication with a fluid source 234 (illustrated in FIG. 2A) so that fluid 234F (illustrated in FIG. 2A) from the fluid source 234 circulates through the fluid circulating band 236. The temperature of the fluid 234F can be regulated (cooled or heated as desired) such that the fluid 234F circulating through the fluid circulating band 236 can effectively control a temperature of the liquid 13 within the container body 12 during the aging process.

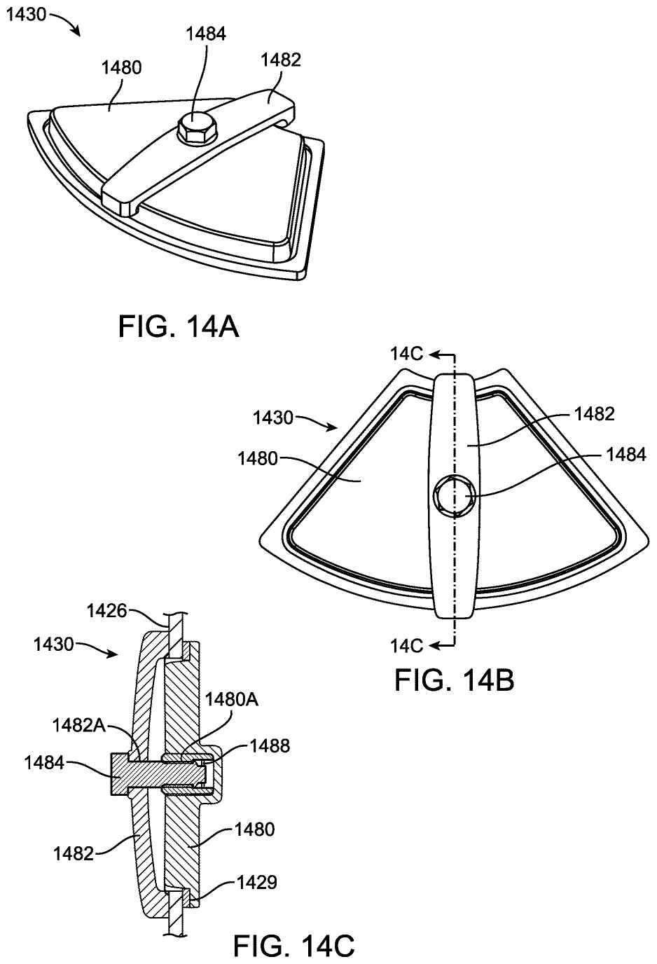

Still further, the cover door assembly 30 is uniquely configured to inhibit a cover door 1480 (illustrated in FIG. 14A) of the cover door assembly 30 from inadvertently being dropped into the liquid 13 that is being aged within the container body 12. Certain embodiments of the cover door assembly 30 will be described in detail herein in relation to FIGS. 14A-14C.

In the embodiment illustrated in FIG. 1A, the container body 12 is generally barrel-shaped having a tubular-shaped side wall 22, a disk-shaped bottom 24, and a substantially disk-shaped top 26. In some embodiments, the side wall 22 can include a plurality of body members, such as a first (upper) body member 22A and a second (lower) body member 22B, that can be welded or otherwise secured together during the manufacturing of the container body 12. Additionally, during the manufacturing process, the bottom 24 can be welded or otherwise secured to the side wall 22 in a sealed manner, or can be integrally formed with the side wall 22; and the top 26 can be secured to the side wall 22 in a sealed manner. Alternatively, the container body 12 can have another suitable design and/or another suitable shape. For example, in certain alternative embodiments, the side wall 22 can be formed as a single, unitary body member.

It is appreciated that the specific identification of the first body member 22A and the second body member 22B is merely for convenience, and either body member 22A, 22B, i.e. the upper body member 22A and the lower body member 22B, can be referred to as the “first body member” or the “second body member”.

As shown, the container body 12 can also include one or more strengthening bands 27 that can be positioned about and adjacent to the side wall 22 to enhance the overall strength and structural stability of the container body 12. In one embodiment, as illustrated, the container body 12 can include three strengthening bands 27 that can be positioned about and adjacent to the side wall 22, and substantially parallel to the top 26 and bottom 24 of the container body 12. More particularly, the container body 12 can include a first strengthening band 27 that is positioned about and adjacent to the side wall 22 toward and/or near the top 26 of the container body 12, a second strengthening band 27 that is positioned about and adjacent to the side wall 22 toward and/or near the bottom 24 of the container body 12, and a third strengthening band 27 that is positioned about and adjacent to the side wall 22 toward and/or near a middle of the container body 12. Alternatively, the container body 12 can include one, two, or more than three strengthening bands 27 that can be positioned about and adjacent to the side wall 22, and substantially parallel to the top 26 and bottom 24 of the container body 12. As described herein, any of the strengthening bands 27 can also be included as part of the temperature controller 14.

As illustrated, the top 26 can include an insert opening 28 that extends through the top 26 of the container body 12. The insert opening 28 can provide selective access to the liquid 13 that is being retained within the container body 12 during the aging process. As noted herein, the insert opening 28 can also provide an access point for inserting the flavor inserts 18 into the chamber 12A as defined by the container body 12, or removing the flavor inserts 18 therefrom.

Additionally, the container assembly 10 can further include the cover door assembly 30 that is used to selectively open and close (and seal) access to the insert opening 28. Stated in another manner, the cover door assembly 30 is selectively movable between a closed position where the insert opening 28 is closed and sealed so that the liquid 13 and the flavor inserts 18 are sealed within the container body 12, and an open position where the insert opening 28 is open and accessible to provide any desired access to the liquid 13 and/or the flavor inserts 18 that are being retained within the container body 12 during the aging process. For example, one or more of the flavor inserts 18 can be positioned within the container body 12 via the insert opening 28.

FIG. 1A further illustrates a seal 29 that can be included as part of the container assembly 10 and/or the cover door assembly 30. In some embodiments, the seal 29 is configured to be positioned substantially between the top 26 and a cover door 80 of the cover door assembly 30, and adjacent to and encircling the insert opening 28. The seal 29 can have a size and shape that largely corresponds with the size and shape of the insert opening 28. With such design, when the cover door assembly 30 and/or the cover door 80 are in the closed position, the seal 29 is configured to effectively seal the insert opening 28 so that the liquid 13 and the flavor inserts 18 are sealed within the container body 12.

Referring briefly to FIG. 1B, FIG. 1B is a partially exploded top perspective view illustration of a portion of the container assembly 10 illustrated in FIG. 1A. FIG. 1B more clearly illustrates certain features and aspects of the container assembly 10. For example, FIG. 1B again illustrates that the container body 12 can include the substantially tubular-shaped side wall 22, the disk-shaped bottom 24, and the substantially disk-shaped top 26. FIG. 1B also clearly illustrates that the side wall 22 can include the first (upper) body member 22A and the second (lower) body member 22B, that can be welded or otherwise secured together during the manufacturing of the container body 12. In some embodiments, one of the strengthening bands 27 can be positioned about and adjacent to the side wall 22 at such position where first body member 22A and the second body member 22B are welded or otherwise secured together during the manufacturing process of the container body 12. Such positioning of one of the strengthening bands 27 helps to better provide desired strength and support for the joint between the first body member 22A and the second body member 22B. FIG. 1B also illustrates the chamber 12A that is defined within the container body 12 and that receives and retains the liquid 13 (illustrated in FIG. 2B) during the aging process.

Certain components of the temperature controller 14 are also shown in FIG. 1B. However, such components of the temperature controller 14 are more clearly illustrated in other figures and will be described in detail in relation to such other figures.

As noted above, FIG. 1B also shows certain portions of the insert retainer assembly 16 that is positioned substantially within the container body 12, and that is configured to retain the plurality of flavor inserts 18 (illustrated in FIG. 7) to impart flavor into the liquid 13 during the aging process. Various features and aspects of different embodiments of the insert retainer assembly 16 will be described in detail herein below.

Returning again to FIG. 1A, as noted above, the temperature controller 14 is coupled to the container body 12 and is configured to control and/or regulate the temperature of the liquid 13 that is being aged within the container body 12. Various features and aspects of different embodiments of the temperature controller 14 will be described in detail herein below.

In some embodiments, the flavor inserts 18 can be selectively positioned within and/or removed from within the container body 12 through the insert opening 28. More particularly, in certain embodiments, the insert retainer assembly 16 (illustrated in FIG. 1B) can be rotated relative to the container body 12 so that each of the flavor inserts 18 (illustrated in FIG. 7) can be inserted into the container body 12 through the insert opening 28 to be received and retained at an appropriate position within the insert retainer assembly 16. Additionally, and/or in the alternative, in other embodiments, the flavor inserts 18 can be inserted into and/or removed from within the container body 12 at a time when the top 26 is not secured to the side wall 22 of the container body 12.

Referring now to FIG. 1C, FIG. 1C is a perspective view illustration of a portion of the container assembly 10 illustrated in FIG. 1A. As shown in FIG. 1C, the container assembly 10 can further include a rotator 31 that can be coupled to the insert retainer assembly 16 (illustrated in FIG. 1B) for selectively rotating the insert retainer assembly 16 and the flavor inserts 18 (illustrated in FIG. 7) within and relative to the container body 12. With the present design, the rotator 31 can be used to selectively rotate the insert retainer assembly 16 and the flavor inserts 18 without opening the container body 12, with the chamber 12A (illustrated in FIG. 1B) sealed and with the chamber 12A full of liquid 13 (illustrated in FIG. 2B).

In one embodiment, the rotator 31 can be a knob that can be manually and selectively rotated by the user. Alternatively, the rotator 31 can include a handle or some other means to enable the user to manually and selectively rotate the insert retainer assembly 16, and, thus, the flavor inserts 18, as the liquid 13 is being aged. Additionally, and/or alternatively, the rotator 31 can include a motor (not illustrated) that enables the user to automatically rotate the insert retainer assembly 16 and the flavor inserts 18 within the chamber 12A.

One purpose for utilizing the rotator 31 to rotate the insert retainer assembly 16 and the flavor inserts 18 is that this operation effectively stirs the liquid 13 that is in the chamber 12A. This operation is easy to perform while the container body 12 is in any orientation, horizontal, vertical, or anywhere in between. This stirring process is sometimes referred to as “stirring of the lees”, and it can be required frequently during the aging of wine and spirits. For example, some winemakers stir the lees every two to four weeks. In certain embodiments, a paddle (not shown) can be further incorporated into the insert retainer assembly 16 to better enable the stirring of the liquid 13 in the chamber 12A during rotation of the insert retainer assembly 16 and the flavor inserts 18 relative to the container body 12.

In certain alternative embodiments, such as with larger container bodies, the container assembly 10 can be modified such that when the container body 12 is being held substantially horizontally during the aging process, additional components can be added so that the container body 12 is rotated relative to the insert retainer assembly 16, with the insert retainer assembly 16 being effectively maintained in a fixed position. Such rotation of the container body 12 relative to the insert retainer assembly 16 and the flavor inserts 18 can also effectively stir the liquid 13 being retained in the chamber 12A during the aging process. Still alternatively, the container body 12 and the insert retainer assembly 16 can be rotated concurrently to stir the liquid 13.

FIG. 1C also illustrates the top 26 of the container body 12, as well as the insert opening 28 that extends through the top 26 of the container body 12, and the cover door assembly 30 that is used to selectively open and close (and seal) access to the insert opening 28. Various features and aspects of different embodiments of the cover door assembly 30 will be described in detail herein below.

Also shown in FIG. 1C is the key lock assembly 20 that is selectively coupled to the container body 12 and/or the insert retainer assembly 16, and that is configured to selectively inhibit relative rotation between the insert retainer assembly 16 and the container body 12. Various features and aspects of different embodiments of the key lock assembly 20 will be described in detail herein below.

Returning again to FIG. 1A, as noted, the container body 12 defines the chamber 12A (illustrated in FIG. 1B) that receives and retains the liquid 13 during the aging process. In certain non-exclusive alternative embodiments, the chamber 12A is sized and shaped to retain approximately 5, 10, 25, 55, 100, 500, 1000, 2500, or 5000 gallons of liquid. However, the chamber 12A can be larger or smaller than any of the specifically noted sizes.

In some embodiments, the container body 12 can further include a bunghole 32 that is positioned within and/or extends through the container body 12. The bunghole 32 is adapted to receive a pipe or other conduit (not illustrated) that can be used for filling the liquid 13 into the chamber 12A, pumping or otherwise removing the liquid 13 from the chamber 12A, or racking of the liquid 13 within the chamber 12A. In alternative embodiments, the bunghole 32 can be positioned in the side wall 22, in the bottom 24, or in the top 26 of the container body 12.

Additionally, as illustrated, the bunghole 32 can be selectively closed and/or sealed through use of a bunghole seal assembly 33. The bunghole seal assembly 33 can have any suitable design in order to effectively close and seal the bunghole 32 when access to the liquid 13 within the chamber 12A through the bunghole 32 is not desired. For example, in certain embodiments, the bunghole seal assembly 33 can include a bunghole seal 33A, a seal support 33B (such as an annular-shaped metal disk in some embodiments), and a clamp 33C that cooperate to selectively close and seal the bunghole 32. Alternatively, the bunghole seal assembly 33 can have another suitable design.

As described herein, the container assembly 10 can be used to impart a flavor on the liquid 13 during the aging process, such as through use of the flavor inserts 18. Additionally, the container assembly 10 can be used to introduce micro-oxygenation (i.e. small amounts of oxygen) into the liquid 13 during the aging process through use of an oxygenator (not shown) that can be positioned in any suitable location within the container body 12, such as substantially adjacent to the insert retainer assembly 16 (illustrated in FIG. 1B). In one embodiment, the container assembly 10 allows for the total control of the aging of the liquid 13, including optimum processing and aging opportunities for the liquid 13. Stated another way, the container assembly 10 can be used to precisely create the perfect environment for aging the liquid 13 so that the highest quality beverage can be achieved. Further, the container assembly 10 can be easily adjusted to be used for different types of liquids and the container assembly 10 can be adjusted during the aging process, if necessary, to alter the aging process.

The type of liquid 13 aged in the container assembly 10 can vary. For example, in certain non-exclusive embodiments, the liquid 13 can be a red wine, white wine, port, whiskey, bourbon, brandy, or other beverages.

In certain embodiments, the container body 12 can be made from a material which imparts no flavor on the liquid 13, such as a stainless-steel material in one such embodiment, and which does not allow for oxygen to be naturally introduced into the liquid 13. Alternatively, in certain embodiments, the container body 12 can be made from a wood material or some other suitable food grade material.

FIG. 2A is a simplified side view illustration of a portion of the container assembly 10 illustrated in FIG. 1A, the container assembly 10 including an embodiment of the liquid temperature control system 14 having features of the present invention. As noted above, the temperature controller 14 can be coupled to the container body 12 and is configured to control and/or regulate a temperature of the liquid 13 (illustrated in FIG. 2B) that is being aged within the container body 12.

FIG. 2A again illustrates that the container body 12 can include the side wall 22, including the first (upper) body member 22A and the second (lower) body member 22B, the bottom 24 and the top 26. The strengthening bands 27 are also shown in FIG. 2A.

In the embodiment shown in FIG. 2A, the temperature controller 14 includes a fluid source 234 (illustrated as a box) that retains a fluid 234F (illustrated as a series of small circles), and one or more fluid circulating bands 236 that are positioned substantially adjacent to the container body 12 and that are in fluid communication with the fluid source 234. In some embodiments, the fluid circulating bands 236 can be positioned to substantially encircle the container body 12.

In this embodiment, two of the strengthening bands 27 are configured to serve dual purposes, namely providing additional strength and structural integrity to the container body 12, as well as functioning as fluid circulating bands 236 as part of the temperature controller 14.

The fluid source 234 can retain any suitable type of fluid that can be utilized to control and/or regulate the temperature of the liquid 13 retained within the container body 12. For example, in one non-exclusive embodiment, the fluid source 234 can include glycol. Alternatively, the fluid source 234 can include another suitable fluid 234F. It is appreciated that the fluid source 234 can also include a temperature regulator 234A (such as a temperature chiller or temperature heater) that regulates a temperature of the fluid 234F from the fluid source 234. It is further appreciated that the fluid source 234 can provide fluid into the fluid circulating bands 236 that is designed to provide a cooling source for the liquid 13 retained within the container body 12, or that is designed to provide a warming source for the liquid 13 retained within the container body 12. Thus, it is appreciated that the fluid 234F in the fluid source 234 can be maintained at any suitable or desired temperature for purposes of controlling and/or regulating the temperature of the liquid 13 retained within the container body 12 in a desired manner.

The fluid circulating bands 236 can have any suitable size and shape. For example, in certain embodiments, the fluid circulating bands 236 can include a band body 338 that is substantially ring-shaped, with a generally “C”-shaped cross-section, that can be welded onto a surface 12A, e.g., an outer surface, of the container body 12 to create a fluid chamber 338A (illustrated in FIG. 2B) therewithin that is configured to circulate the fluid 234F from the fluid source 234 therethrough. In other embodiments, the fluid circulating bands 236 can include the band body 338 that is substantially hollow, ring-shaped, with a generally rectangular-shaped cross-section that can be welded onto the outer surface 12S of the container body 12, and that defines the fluid chamber 338A therewithin that is configured to circulate the fluid 234F from the fluid source 234 therethrough. Stated in another manner, in many embodiments, the band body 338 of the fluid circulating bands 236 defines at least a portion of the fluid chamber 338A that is configured to circulate the fluid 234F from the fluid source 234 therethrough adjacent to the container body 12.

In various embodiments, the fluid circulating bands 236 are not quite fully ring-shaped so that the fluid 234F does not continuously flow completely around the entire container body 12. As illustrated, the fluid circulating bands 236 each include a fluid inlet 236A through which the fluid 234F is introduced into the fluid circulating band 236, and a fluid outlet 236B through which the fluid 234F exits the fluid circulating band 236. A fluid inflow conduit (not shown), such as a hose, can be used to direct the fluid 234F from the fluid source 234 into the fluid circulating band 236 via the fluid inlet 236A, and a fluid outflow conduit (not shown), such as a hose, can be used to direct the fluid 234F out of the fluid circulating band 236 via the fluid outlet 236B back to the fluid source 234 or to another fluid circulating band 236.

In some embodiments, a plurality of fluid circulating bands 236 can be connected in series with fluid 234F from the fluid source 234. The plurality of fluid circulating bands 236 that are connected in series can be coupled to the same container body 12 or can be coupled to different container bodies 12. In this manner, the fluid 234F can flow from one fluid circulating band 236 to the next fluid circulating band 236 without returning to the fluid source 234 therebetween. With such design, the fluid outflow conduit from one fluid circulating band 236 can be in fluid communication with the fluid inflow conduit for the next fluid circulating band 236. After a number of such fluid circulating bands 236 are thus connected in fluid communication in a serial manner, the fluid 234F can then be returned to the fluid source 234 for reuse. It is appreciated that any suitable number of fluid circulating bands 236 can be connected in series.

Alternatively, the fluid 234F from the fluid source 234 can be provided in parallel to each of the fluid circulating bands 236, such that the fluid 234F flows directly from the fluid source 234 into the fluid circulating band 236 via the fluid inlet 236A (through the fluid inflow conduit), and then the fluid 234F is directly returned to the fluid source 234 from the fluid circulating band 236 via the fluid outlet 236B (through the fluid outflow conduit).

It is appreciated that the fluid 234F being returned to the fluid source 234 can then be reused as desired as the overall fluid 234F at the fluid source 234 can be temperature-regulated, such as through use of the temperature regulator 234A.

FIG. 2B is a simplified sectional view illustration of the container assembly 10 cut on line 2B-2B in FIG. 2A. As illustrated, the container body 12 of the container assembly 10 can define the chamber 12A therein, which can be used to receive and retain any suitable liquid 13 (illustrated as a plurality of small circles) during an aging process.

FIG. 2B further illustrates the side wall 22, the bottom 24 and the top 26 that can be included as part of the container body 12. Also shown in FIG. 2B is a portion of the temperature controller 14, such as a portion of two hollow, substantially ring-shaped, fluid circulating bands 236, and the bunghole 32 that is positioned within and/or extends through the container body 12. The connector assembly 540 (illustrated in FIG. 5B), the mount assembly 50 (illustrated in FIG. 1A) and the insert retainer assembly 16 (illustrated in FIG. 1B) are not illustrated in FIG. 2B for purposes of clarity. However, it is appreciated that the connector assembly 540, the mount assembly 50 and the insert retainer assembly 16 would typically be included as part of the container assembly 12 when the side walls 22, the bottom 24 and the top 26 are secured (such as welded) together such as shown in FIG. 2B.

It is further appreciated that the container body 12, including the side wall 22, the bottom 24 and the top 26, can have any desired thickness to more effectively retain the liquid 13 therein during the aging process. In certain embodiments, the thickness of the container body 12, including the side wall 22, can be somewhat smaller than in currently available container bodies due to the inclusion of the strengthening bands 27. Stated in another manner, the additional strength and structural stability that can be provided by the inclusion of the strengthening bands 27 enables the container body 12 to be designed to have a somewhat thinner overall cross-section.

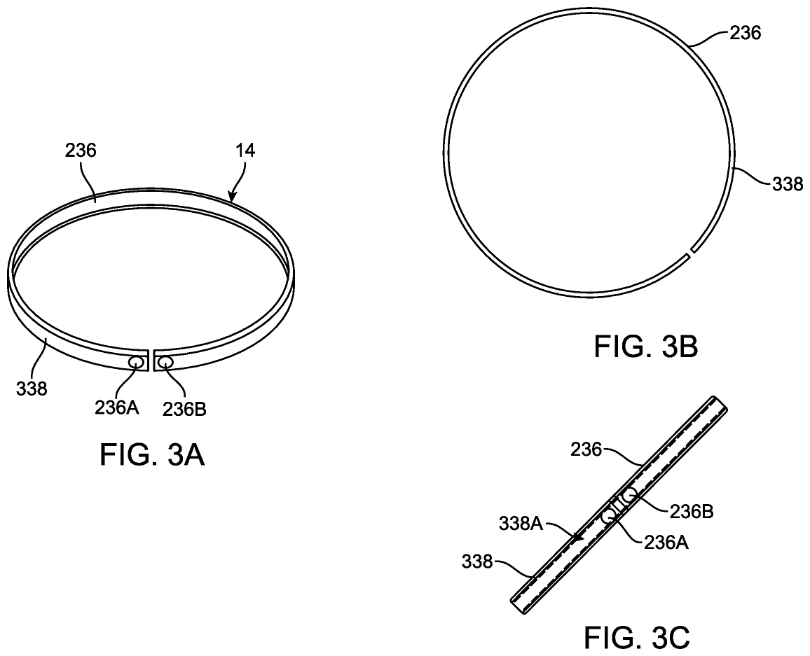

FIG. 3A is a simplified perspective view illustration of an embodiment of a fluid circulating band 236 that can be included as part of the liquid temperature control system 14. As described herein, it is further appreciated that with the fluid circulating bands 236 typically being positioned adjacent to the side wall 22 (illustrated in FIG. 1A) of the container body 12 (illustrated in FIG. 1A), and also potentially being further used as strengthening bands 27 (illustrated in FIG. 1A), the fluid circulating bands 236 can also be considered to be part of the container body 12.

As shown, in various embodiments, the fluid circulating band 236 can include a body band 338 that can be substantially ring-shaped, but not fully ring-shaped. In some embodiments, the fluid circulating band 236 and/or the body band 338 can be configured to form between 95% and 99.9% of a fully formed ring.

As further shown, in certain embodiments, the band body 338 of the fluid circulating band 236 has a generally “C”-shaped cross-section. Alternatively, the band body 338 of the fluid circulating band 236 can have another suitably shaped cross-section.

FIG. 3A further shows the fluid inlet 236A through which the fluid 234F (illustrated in FIG. 2A) from the fluid source 234 (illustrated in FIG. 2A) enters into the fluid circulating band 236, and the fluid outlet 236B through which the fluid 234F from the fluid source 234 exits from the fluid circulating band 236. It is appreciated that the fluid inlet 236A and the fluid outlet 236B can have any suitable size and shape so that the fluid 234F from the fluid source 234 can easily and conveniently enter into and exit from the fluid circulating band 236.

It is appreciated that the fluid circulating band 236 and/or the body band 338 can be any suitable size, depending on the size of the container body 12 (illustrated in FIG. 1A) with which the fluid circulating band 236 is used, as well as the specific location about and adjacent to the container body 12 where the fluid circulating band 236 will be positioned. It is further appreciated that the fluid circulating band 236 and/or the band body 338 can have any suitable width, and can define any suitably sized fluid chamber 338A (illustrated in phantom in FIG. 3C) therein depending on the volume of fluid 234F to be circulated through the fluid circulating band 236 at any given time.

The fluid circulating band 236 and/or the band body 338 can be formed from any suitable materials. For example, in certain non-exclusive embodiments, the fluid circulating band 236 and/or the band body 338 can be formed from stainless steel or another suitable metallic material. Alternatively, the fluid circulating band 236 can be made from other suitable materials.

FIG. 3B is a simplified top view illustration of the fluid circulating band 236 illustrated in FIG. 3A. As clearly illustrated in FIG. 3B, the fluid circulating band 236 and/or the band body 338 is substantially, but not fully, ring-shaped.

FIG. 3C is a simplified side view illustration of the fluid circulating band 236 illustrated in FIG. 3A. As shown, the band body 338 of the fluid circulating band 236 defines at least a portion of the fluid chamber 338A (illustrated in phantom) therein. It is appreciated that the size and/or volume of the fluid chamber 338A can be varied based on the specific requirements of the temperature controller 14 (illustrated in FIG. 1A). It is further appreciated that the size and shape of the fluid circulating band 236 and/or the band body 338, as well as a thickness of the material used to form the fluid circulating band 236 and/or the band body 338, will influence the size and/or volume of the fluid chamber 338A.

FIG. 3C also again illustrates the fluid inlet 236A and the fluid outlet 236B that are provided within the fluid circulating band 236 to enable the fluid 234F (illustrated in FIG. 2A) from the fluid source 234 (illustrated in FIG. 2A) can easily and conveniently enter into and exit from the fluid circulating band 236.

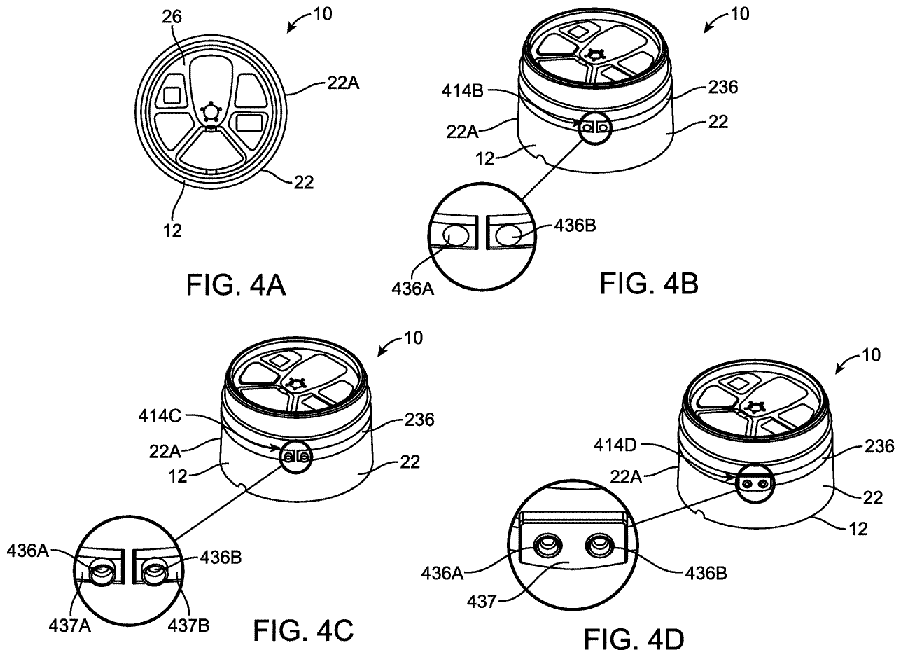

FIG. 4A is a simplified top view illustration of a portion of the container assembly 10 illustrated in FIG. 1A. In particular, FIG. 4A is a simplified top view illustration that shows the first body member 22A of the side wall 22 and the top 26 of the container body 12.

FIG. 4B is a simplified top perspective view illustration of the portion of the container assembly 10 illustrated in FIG. 4A, including a portion of an embodiment of the liquid temperature control system 414B that is positioned about and adjacent to the first body member 22A of the side wall 22 of the container body 12. In particular, FIG. 4B shows an embodiment of the fluid inlet 436A and the fluid outlet 436B that are included within the fluid circulating band 236 of the temperature controller 414B. It should be noted that, for example, the fluid inlet 436A and/or the fluid outlet 436B can include threads (not shown) or another type of connector that allows for coupling of one or more fluid conduits (not shown) that are also connected with the fluid source 234 (illustrated in FIG. 2A).

FIG. 4C is a simplified top perspective view illustration of the portion of the container assembly 10 illustrated in FIG. 4A, including a portion of another embodiment of the liquid temperature control system 414C that is positioned about and adjacent to the first body member 22A of the side wall 22 of the container body 12. In particular, FIG. 4C shows another embodiment of the fluid inlet 436A and the fluid outlet 436B that are included within the fluid circulating band 236 of the temperature controller 414C. More specifically, in this embodiment of the temperature controller 414C, the fluid inlet 436A is incorporated and/or covered with a first (inlet) fluid flow housing member 437A and the fluid outlet 436B is incorporated and/or covered with a second (outlet) fluid flow housing member 437B. It is appreciated that the first (inlet) fluid flow housing member 437A and the second (outlet) fluid flow housing member 437B can have any suitable size and shape depending on the size and shape of the fluid inlet 436A and the fluid outlet 436B, respectively.

FIG. 4D is a simplified top perspective view illustration of the portion of the container assembly 10 illustrated in FIG. 4A, including a portion of still another embodiment of the liquid temperature control system 414D that is positioned about and adjacent to the first body member 22A of the side wall 22 of the container body 12. In particular, FIG. 4D shows still another embodiment of the fluid inlet 436A and the fluid outlet 436B that are included within the fluid circulating band 236 of the temperature controller 414D. More specifically, in this embodiment of the temperature controller 414D, the fluid inlet 436A and the fluid outlet 436B are both incorporated and/or covered with a single fluid flow housing member 437. With this design, when the fluid flow housing member 437 is coupled to the fluid circulating band 236, these components cooperate to form a full ring that is positioned about and adjacent to the container body 12. It is appreciated that the fluid flow housing member 437 can have any suitable size and shape depending on the size and shape of the fluid inlet 436A and the fluid outlet 436B, as well as the relative spacing between the fluid inlet 436A and the fluid outlet 436B. It is further appreciated that the full ring that is formed when the fluid flow housing member 437 is coupled to the fluid circulating band 236 in this embodiment helps to maintain the fluid circulating band 236 in its desired position about and adjacent to the container body 12.

FIG. 5A is another simplified side view illustration of the container assembly 10 illustrated in FIG. 1A. More particularly, FIG. 5A is another simplified side view illustration showing the container body 12 of the container assembly 10.

Additionally, FIG. 5B is a simplified sectional view illustration of the container assembly 10 cut on line 5B-5B in FIG. 5A, the container assembly 10 including an embodiment of the insert retainer assembly 516 having features of the present invention. The insert retainer assembly 516 is configured to receive and retain at least one, and preferably a plurality of spaced apart flavor inserts 18 (illustrated in FIG. 7). In certain embodiments, the insert retainer assembly 516 and the flavor inserts 18 are designed to allow for the flavor inserts 18 to be easily, selectively, and individually added or removed from the container body 12, such as through the insert opening 28 (illustrated in FIG. 1A) in the top 26 of the container body 12, and/or when the top 26 is not secured to the side wall 22 of the container body 12. Additionally, in some embodiments, the flavor inserts 18 are received and retained by the insert retainer assembly 516 in such manner as to inhibit movement of the flavor inserts 18 when the container body 12 is full of the liquid 13 (illustrated in FIG. 2B).

The design of the insert retainer assembly 516 can be varied. In certain embodiments, the insert retainer assembly 516 can include a connector assembly 540, a first (upper) alignment rack 542, a second (lower) alignment rack 544, and a retainer rack 545 including a retainer base 546 and one or more insert retainers 548 that are coupled to the retainer base 546. Alternatively, the insert retainer assembly 516 can have a different design, with more components or fewer components than those noted above. For example, in certain non-exclusive alternative embodiments, the insert retainer assembly 516 can be designed with only one alignment rack.

The connector assembly 540 fixedly couples the first alignment rack 542 and the second alignment rack 544 to the retainer rack 545 and is used to connect the insert retainer assembly 516 to the container body 12. In one embodiment, the connector assembly 540 is a generally tube-shaped member that extends along a container longitudinal axis, that maintains the first alignment rack 542 spaced apart from the top 26, maintains the retainer rack 545 spaced apart from the bottom 24, and maintains the second alignment rack 544 spaced apart from and slightly above the retainer rack 545. In certain embodiments, the connector assembly 540 can be formed from multiple components that can be selectively secured to one another. For example, in many embodiments, a proximal end 540P of the connector assembly 540 can be a separate component from the remainder of the connector assembly 540. In such embodiments, the proximal end 540P of the connector assembly 540 can be secured, e.g., welded, to the rest of the connector assembly 540 during the manufacturing process. Further, the proximal end 540P can extend through the top 26 of the container body 12. Additionally, in some embodiments, the portion of the connector assembly 540 other than the proximal end 540P can be formed from a pair of generally tube-shaped members, such as a first connector member body 540F and a second connector member body 540S that can be connected and/or coupled together by a connector member coupler 540C. In certain such embodiments, the connector member coupler 540C can define a sampling aperture 540A so that the operator can selectively remove samples of the liquid 13 from within the container body 12 through the bunghole 32 and the sampling aperture 540A. Alternatively, the connector assembly 540 can have another suitable design, such as a unitary, one-piece design. Still alternatively, for example, the connector assembly 540 can have another suitable design and/or can maintain the position of one or more of the alignment racks 542, 544 and the retainer rack 545 to be different than that illustrated in FIG. 5B.

The insert retainer assembly 516 can be formed from any suitable materials. For example, in some embodiments, the components of the insert retainer assembly 516 can be made of stainless steel or another suitable metallic material. Alternatively, the components of the insert retainer assembly 516 can be made from other suitable materials.

In certain embodiments, the container assembly 10 can further include a mount assembly 550 that couples, secures and/or mounts the insert retainer assembly 516 to the container body 12. In some embodiments, the mount assembly 550 includes a lower mount 552 for coupling, securing and/or mounting the connector assembly 540 to the bottom 24 of the container body 12, and an upper mount 554 for coupling, securing and/or mounting the connector assembly 540 to the top 26 of the container body 12. In one embodiment, each mount 552, 554 includes a bearing. With this design, the mount assembly 550 allows for easy and controlled relative rotation between the insert retainer assembly 516 and the container body 12.

More specifically, in one embodiment, the lower mount 552 is substantially centrally located along the bottom 24 of the container body 12, and is adapted to rotatably receive and retain a distal end of the connector assembly 540. Somewhat similarly, the upper mount 554 is substantially centrally located along the top 26 of the container body 12, and is adapted to rotatably receive and retain the connector assembly 540 with the proximal end 540P of the connector assembly 540 extending therethrough. Moreover, the upper mount 554 can be adapted to seal the connector assembly 540 to the top 26 of the container body 12 with the proximal end 540P extending therethrough.

In certain embodiments, the first alignment rack 542 includes a central, tubular-shaped alignment hub 542H (illustrated more clearly in FIG. 1B), and one or more alignment arms 542A (illustrated more clearly in FIG. 1B) that extend radially from the alignment hub 542H. In one embodiment, the first alignment rack 542 includes four alignment arms 542A that are spaced apart from one another and that cantilever away from the alignment hub 542H. Alternatively, the first alignment rack 542 can include more than four or fewer than four alignment arms 542A.

Further, the design of each alignment arm 542A can be varied. For example, each alignment arm 542A can define a plurality of spaced apart alignment guides 542G (illustrated in FIG. 1B) that are used to guide the flavor inserts 18 during installation and to maintain the flavor inserts 18 spaced apart from each other when positioned within the container body 12. For example, each alignment guide 542G can be a generally rectangular-shaped aperture that is slightly larger than the cross-section of the flavor inserts 18. In one embodiment, the alignment guides 542G are aligned radially along the respective alignment arm 542A. Alternatively, one or more of the alignment guides 542G can be another shape, such as a circle, an oval, a triangle, or an octagon.

Substantially similarly, in certain embodiments, the second alignment rack 544 includes a central, tubular-shaped alignment hub, and one or more alignment arms that extend radially from the alignment hub. In one embodiment, the second alignment rack 544 includes four alignment arms that are spaced apart from one another and that cantilever away from the alignment hub. The alignment arms of the second alignment rack 544 are configured to be aligned with the alignment arms 542A of the first alignment rack 542. Alternatively, the second alignment rack 544 can include more than four or fewer than four alignment arms.

Further, each alignment arm of the second alignment rack 544 can also define a plurality of spaced apart alignment guides that are used to guide the flavor inserts 18 during installation and to maintain the flavor inserts 18 spaced apart from each other when positioned within the container body 12. For example, each alignment guide can be a generally rectangular-shaped aperture that is slightly larger than the cross-section of the flavor inserts 18. In one embodiment, the alignment guides are aligned radially along the respective alignment arm. Alternatively, one or more of the alignment guides can be another shape, such as a circle, an oval, a triangle, or an octagon.

The alignment guides 542G on each of the alignment arms 542A of the first alignment rack 542 are configured to be aligned with the alignment guides on each of the alignment arms of the second alignment rack 544. With such design, a flavor insert 18 that is directed and/or positioned through a particular alignment guide on one of the alignment arms 542A of the first alignment rack 542 will also easily be directed and/or positioned through a corresponding alignment guide on one of the alignment arms of the second alignment rack 544.

In some embodiments, the retainer rack 545 and/or the retainer base 546 includes a central, tubular-shaped retainer hub 546H (illustrated more clearly in FIG. 1B), and one or more retainer arms 546A (illustrated more clearly in FIG. 1B) that extend radially from the retainer hub 546H. In this embodiment, the retainer rack 545 and/or the retainer base 546 includes four retainer arms 546A that are spaced apart from one another and that cantilever away from the retainer hub 546H. Alternatively, the retainer rack 545 and/or the retainer base 546 can include more than four or fewer than four retainer arms 546A. It is appreciated that the number of retainer arms 546A will generally correspond to the number of alignment arms 542A on each of the first alignment rack 542 and the second alignment rack 544.

As noted herein, the container assembly 10 is commonly maintained substantially horizontally during the aging process. In such positioning, the container assembly 10 and/or the container body 12 can be positioned such that the bunghole 32 is at the top of the horizontal container body 12. When it is desired to sample the liquid 13 during the aging process, and when the container body 12 is positioned in such manner, the operator can extend a sample collector (not shown) into the chamber 12A through the bunghole 32 and subsequently through the sampling aperture 540A that can be formed through the connector assembly 540. As shown, the sampling aperture 540A in the connector assembly 540 will typically be aligned with the bunghole 32. In this manner, the operator is able to obtain a sample of the liquid 13 from what, in this position, is the bottom (or lowest point) of the container assembly 10.

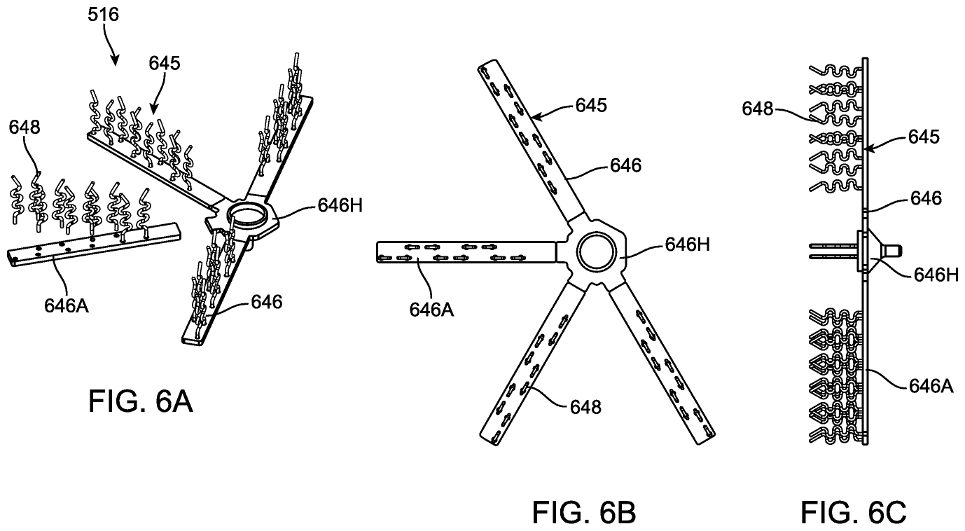

FIG. 6A is a simplified partially exploded perspective view illustration of an embodiment of the retainer rack 645 having features of the present invention that can be included as part of the insert retainer assembly 516 of the container assembly 10 (illustrated in FIG. 1A). More particularly, FIG. 6A is a simplified partially exploded perspective view illustration of an embodiment of the retainer base 646, the retainer hub 646H, and the retainer arms 646A that can form at least a portion of the retainer rack 645.

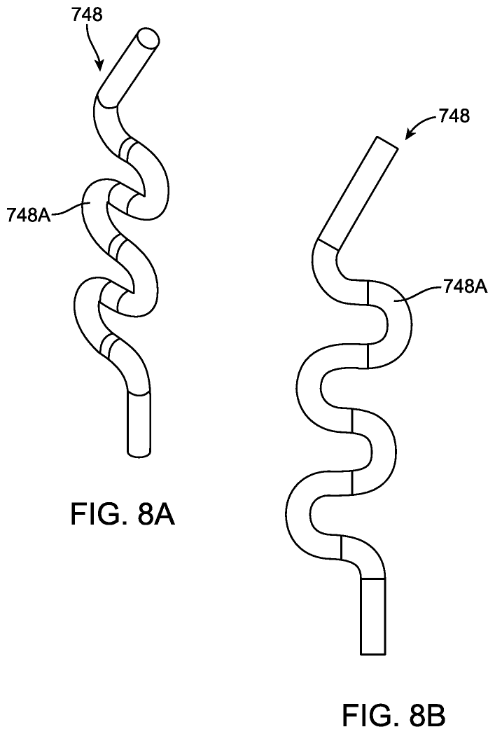

Additionally, as further illustrated in FIG. 6A, each retainer arm 646A can include a plurality of spaced apart insert retainers 648 that are coupled to the retainer base 646 and that are aligned with corresponding alignment guides 542G (illustrated in FIG. 1B) on corresponding alignment arms 542A (illustrated in FIG. 5B) of the first alignment rack 542 (illustrated in FIG. 5B) and the second alignment rack 544 (illustrated in FIG. 5B). With such design, a flavor insert 18 (illustrated in FIG. 7) that is directed and/or positioned through corresponding alignment guides 542G on the first alignment rack 542 and the second alignment rack 544 will then easily be directed downward into a corresponding insert retainer 648 to be effectively received and retained by the insert retainer 648. It is appreciated that when the flavor inserts 18 are effectively received and retained by the insert retainers 648, each flavor insert 18 will be positioned within the corresponding alignment guides 542G on the first alignment rack 542 and the second alignment rack 544, as well as being retained by the corresponding insert retainer 648, substantially simultaneously. Details and aspects of certain embodiments of the insert retainer 648 will be described in relation to FIG. 7 and FIGS. 8A and 8B.

As illustrated, in certain, non-exclusive embodiments, the retainer rack 645 includes four retainer arms 646A that are spaced apart from one another in a substantially semi-circular arrangement about the retainer hub 646H. With such design, when the container assembly 10 (illustrated in FIG. 1A) is positioned substantially horizontally during the aging process, the flavor inserts 18 can be received and retained by the insert retainers 648 such that the flavor inserts 18 are positioned only in the lower half of the container body 12. Thus, with such configuration, all of the flavor inserts 18 can be positioned in the liquid 13 (illustrated in FIG. 2B) even if the chamber 12A (illustrated in FIG. 1B) is only half full of the liquid 13 being aged. Alternatively, the retainer arms 646A can be positioned and/or arranged in another suitable manner.

FIG. 6B is a simplified top view illustration of the retainer rack 645 illustrated in FIG. 6A. In particular, FIG. 6B is a simplified top view illustration of the retainer rack 645 that shows the retainer base 646, the retainer hub 646H, the retainer arms 646A, and the retainer inserts 648 of the retainer rack 645.

FIG. 6C is a simplified side view illustration of the retainer rack 645 illustrated in FIG. 6A. In particular, FIG. 6C is a simplified side view illustration of the retainer rack 645 that again shows the retainer base 646, the retainer hub 646H, the retainer arms 646A, and the retainer inserts 648 of the retainer rack 645.

FIG. 7 is a simplified schematic side view illustration of an embodiment of an insert retainer 748 having features of the present invention that can be included as part of the insert retainer assembly 516 (illustrated in FIG. 5B). It should be noted that one or more of the insert retainers 648 in FIG. 6A can be similar in design to the insert retainer 748 of FIG. 7. FIG. 7 also illustrates the insert retainer 748 being coupled to a retainer base 746. Additionally, FIG. 7 further illustrates a simplified schematic side view of three flavor inserts 18, i.e. a first flavor insert 18A, a second flavor insert 18B (illustrated in phantom), and a third flavor insert 18C (illustrated in phantom), which can each be alternatively, selectively, received and retained by the insert retainer 748.

The flavor inserts 18 are used to impart a desired flavor on the liquid 13 (illustrated in FIG. 2B) during the aging process. The number of flavor inserts 18 utilized and the type and size of the flavor inserts 18 utilized can be adjusted to precisely adjust the desired outcome of the liquid 13. With this design, the perfect material and the perfect amount of material for the liquid 13 for extracting flavor during the aging process can be utilized. With the ability to change the number and types of flavor inserts 18 utilized during the aging process, there is greater flexibility in the timing and the flavor development of the liquid 13 during the aging process. As non-exclusive examples, one or more of the flavor inserts 18 can be made of different species of wood, such as white oak, red oak, redwood, douglas fir, maple, birch, hickory, and/or any combination thereof. The ability to impact the flavor of the liquid 13 by inserting different types of flavor inserts 18 into the chamber 12A (illustrated in FIG. 1B) is a great benefit in creating the finest beverage possible during the aging process.

In one embodiment, each flavor insert 18 is generally thin beam-shaped and has a generally rectangular-shaped cross-section. Alternatively, for example, one or more of the flavor inserts 18 can have another cross-sectional shape, such as a circle, an oval, a triangle, or an octagon.

Additionally, in certain embodiments, each flavor insert 18 includes a distal end 18D that is received and retained by the insert retainer 748, and an opposed proximal end (not shown in FIG. 7, as it would extend much further away from the retainer rack 645 and be typically positioned above the first alignment rack 542 (illustrated in FIG. 5B)) that can be accessed and held during a process of removing the flavor insert 18 from within the container body 12 and/or inserting the flavor insert 18 into the container body 12.

In one embodiment, the insert retainer assembly 516 selectively retains the flavor inserts 18 spaced apart from the container body 12 (illustrated in FIG. 5A). Additionally, in this embodiment, the insert retainer assembly 516 retains the flavor inserts 18 spaced apart from each other so that almost the entirety of each flavor insert 18 is exposed to the liquid 13 in the chamber 12A.

As shown in FIG. 7, the insert retainer 748 includes a first retainer member 748A and a second retainer member 748B that are each coupled to and cantilever away from the retainer base 746. In certain embodiments, as illustrated, each of the retainer members 748A, 748B can have a design including a plurality of generally “S”-shaped curves that are oriented to provide a plurality of alternative, engagement regions 760 for the insert retainer 748. In various embodiments, the retainer members 748A, 748B can be somewhat resilient and/or flexible in order to more effectively receive and retain alternative flavor inserts 18 of different thicknesses. Stated in another manner, the retainer members 748A, 748B are movable relative to one another, i.e. can flex relative to one another, between a non-deflected position (before the retainer members 748A, 748B are retaining a flavor insert 18) and a deflected position (while the retainer members 748A, 748B are retaining a flavor insert 18). It is appreciated that the resilience and/or flexibility of the retainer members 748A, 748B can be varied to suit the requirements of the container assembly 10. It should also be noted that the amount of flex in the retainer members 748A, 748B will depend on the size of the flavor inserts 18.

As shown, in one, non-exclusive implementation, each engagement region 760 is positioned at a different height (when the container assembly 10 (illustrated in FIG. 1A) is in an upright position) relative to the retainer base 746. Additionally, each engagement region 760 has a different separation distance, or spacing 762, between the retainer members 748A, 748B. It is appreciated that the actual spacing 762 as illustrated for each engagement region 760 is a (slightly) deflected spacing, and, thus, may sometimes be referred to herein as a “deflected spacing”. In particular, during use of the insert retainer 748, the retainer members 748A, 748B, when not retaining a flavor insert 18, will have a certain non-deflected (or relaxed) spacing, i.e. with the retainer members 748A, 748B being positioned in the non-deflected position relative to one another. Subsequently, when a flavor insert 18 is inserted into the container body 12 to be received and retained (and frictionally engaged) by the insert retainer 748, the flavor insert 18 contacting the retainer members 748A, 748B will cause the retainer members 748A, 748B to flex slightly away from one another to the deflected position, with a deflected spacing 762 defined therebetween. Thus, it is recognized that the retainer members 748A, 748B are movable relative to one another between a non-deflected position, with a corresponding non-deflected spacing, and a deflected position, with a corresponding deflected spacing 762.

The insert retainer 748 can include any suitable number of engagement regions 760. For example, in the embodiment illustrated in FIG. 7, the insert retainer 748 includes (i) a first engagement region 760A, which is positioned at a first height 760H1 relative to the retainer base 746 that is closest to the retainer base 746, having a first separation distance, or first (deflected) spacing 762A; (ii) a second engagement region 760B, which is positioned above the first engagement region 760A and at a second height 760H2 relative to the retainer base 746, having a second separation distance, or second (deflected) spacing 762B that is larger than the first (deflected) spacing 762A; and (iii) a third engagement region 760C, which is positioned above the second engagement region 760B and at a third height 760H3 relative to the retainer base 746, having a third separation distance, or third (deflected) spacing 762C that is larger than the first (deflected) spacing 762A and the second (deflected) spacing 762B. With this design, each insert retainer 748 includes (i) the first engagement region 760A that is configured to receive and retain (and frictionally engage) the first flavor insert 18A, but that does not receive and retain (and frictionally engage) the second flavor insert 18B or the third flavor insert 18C; (ii) the second engagement region 760B that is configured to receive and retain (and frictionally engage) the second flavor insert 18B, but that does not receive and retain (and frictionally engage) the first flavor insert 18A or the third flavor insert 18C; and (iii) the third engagement region 760C that is configured to receive and retain (and frictionally engage) the third flavor insert 18C, but that does not receive and retain (and frictionally engage) the first flavor insert 18A or the second flavor insert 18B.

Alternatively, the insert retainer 748 can have more than three engagement regions 760 or fewer than three engagement regions 760, and/or the spacing 762 between the retainer members 748A, 748B can be different than what is illustrated.

Still alternatively, the design of the insert retainer 748 and/or the retainer members 748A, 748B can be modified such that more than one of the engagement regions 760A, 760B, 760C can be positioned at the same height relative to the retainer base 746. More specifically, in such alternative embodiments, the design of the retainer members 748A, 748B can be modified to define (i) a first engagement region that is configured to receive and retain (and frictionally engage) the first flavor insert 18A, but that does not receive and retain (and frictionally engage) the second flavor insert 18B; and (ii) a second engagement region that is configured to receive and retain (and frictionally engage) the second flavor insert 18B, but that does not receive and retain (and frictionally engage) the first flavor insert 18A, with both the first engagement region and the second engagement region being at the same height relative to the retainer base 746.

As illustrated, each engagement region 760 of the insert retainer 748 has a (deflected) spacing 762 that is configured to receive and retain a flavor insert 18 having a different thickness. More particularly, in this embodiment, (i) the first engagement region 760A has a first (deflected) spacing 762A that is designed so that the first engagement region 760A clamps, receives and retains (and frictionally engages) a first flavor insert 18A having a first thickness 764A, such as approximately seven millimeters in one specific example; (ii) the second engagement region 760B has a second (deflected) spacing 762B that is designed so that the second engagement region 760B clamps, receives and retains (and frictionally engages) a second flavor insert 18B having a second thickness 764B, such as approximately 12 millimeters in one specific example, that is larger than the first thickness 764A; and (iii) the third engagement region 760C has a third (deflected) spacing 762C that is designed so that the third engagement region 760C clamps, receives and retains (and frictionally engages) a third flavor insert 18C having a third thickness 764C, such as approximately 18 millimeters in one specific example, that is larger than the first thickness 764A and the second thickness 764B. Stated in another manner, the first flavor insert 18A is received and retained (and frictionally engaged) substantially adjacent to the first engagement region 760A, the second flavor insert 18B is received and retained (and frictionally engaged) substantially adjacent to the second engagement region 760B, and the third flavor insert 18C is received and retained (and frictionally engaged) substantially adjacent to the third engagement region 760C.

Thus, as illustrated, the first (deflected) spacing 762A is at least substantially equal to the first thickness 764A of the first flavor insert 18A, the second (deflected) spacing 762B is at least substantially equal to the second thickness 764B of the second flavor insert 18B, and the third (deflected) spacing 762C is at least substantially equal to the third thickness 764C of the first flavor insert 18C. Additionally, in order that the insert retainer 748 can effectively receive and retain the first flavor insert 18A, the second flavor insert 18B and the third flavor insert 18C adjacent to the first engagement region 760A, the second engagement region 760B and the third engagement region 760C, respectively, it is appreciated that (i) the first engagement region 760A will have a first (non-deflected) spacing that is slightly less than the first thickness 764A of the first flavor insert 18A, (ii) the second engagement region 760B will have a second (non-deflected) spacing that is slightly less than the second thickness 764B of the second flavor insert 18B, and (iii) the third engagement region 760C will have a third (non-deflected) spacing that is slightly less than the third thickness 764C of the third flavor insert 18C.

It is appreciated that the thicknesses 764A, 764B, 764C of the flavor inserts 18A, 18B, 18C, respectively, can be different than, i.e. greater than or less than, the example thicknesses specifically noted above. Thus, it is further appreciated that the (deflected) spacings 762A, 762B, 762C of the engagement regions 760A, 760B, 760C, respectively, can be any suitable values in order to effectively receive and retain (and frictionally engage) the flavor inserts 18A, 18B, 18C of any suitable thicknesses 764A, 764B, 764C. However, it is also appreciated that the differences in thicknesses 764A, 764B, 764C of the flavor inserts 18A, 18B, 18C will typically be great enough that (i) the first engagement region 760A can effectively receive and retain (and frictionally engage) the first flavor insert 18A having the first thickness 764A, but cannot effectively receive and retain (and frictionally engage) the second flavor insert 18B having the second thickness 764B or the third flavor insert 18C having the third thickness 764C, (ii) the second engagement region 760B can effectively receive and retain (and frictionally engage) the second flavor insert 18B having the second thickness 764B, but cannot effectively receive and retain (and frictionally engage) the first flavor insert 18A having the first thickness 764A or the third flavor insert 18C having the third thickness 764C, and (iii) the third engagement region 760C can effectively receive and retain (and frictionally engage) the third flavor insert 18C having the third thickness 764C, but cannot effectively receive and retain (and frictionally engage) the first flavor insert 18A having the first thickness 764A or the second flavor insert 18B having the second thickness 764B.

The retainer members 748A, 748B and/or the insert retainer 748 can be formed from any suitable materials. For example, in certain embodiments, the retainer members 748A, 748B and/or the insert retainer 748 can be made of stainless steel or another suitable metallic material. Alternatively, the components of the retainer members 748A, 748B and/or the insert retainer 748 can be made from other suitable materials.

It is appreciated that the first retainer member 748A and the second retainer member 748B can be designed to be substantially identical to one another, but can be positioned effectively as mirror images of one another. Additionally, it is further appreciated that the use of the terms “first retainer member” and “second retainer member” is merely for convenience and ease of description, and either retainer member 748A, 748B can be defined as the “first retainer member” and/or the “second retainer member”.

FIG. 8A is a simplified perspective view illustration of a portion of the insert retainer 748 illustrated in FIG. 7. In particular, FIG. 8A is a simplified perspective view illustration of one of the retainer members 748A of the insert retainer 748.

FIG. 8B is a simplified side view illustration of the portion of the insert retainer 748 illustrated in FIG. 8A. In particular, FIG. 8B is a simplified side view illustration of one of the retainer members 748A that illustrates the generally “S”-shaped design of the retainer members 748A. As noted above, the generally “S”-shaped design of each of the retainer members 748A, 748B (illustrated in FIG. 7) are configured so that the retainer members 748A, 748B cooperate with one another to form the engagement regions 760 (illustrated in FIG. 7) to effectively receive and retain one of the flavor inserts 18 (illustrated in FIG. 7).

The specific size, shape and dimensions of the generally “S”-shaped design of the retainer member 748B can be varied to suit the specific requirements of the container assembly 10 (illustrated in FIG. 1A) and/or the size, shape and dimensions of the flavor inserts 18 (illustrated in FIG. 7).

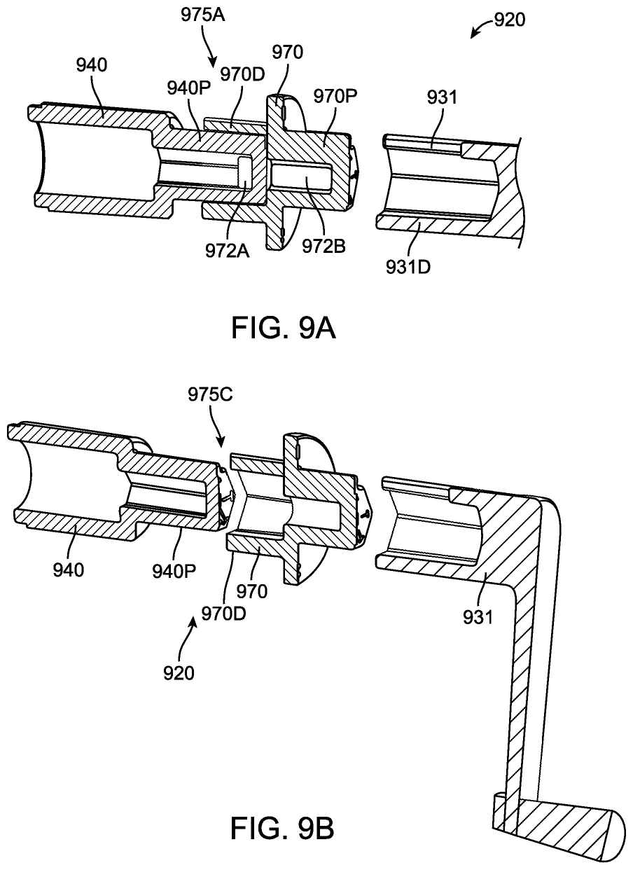

FIG. 9A is a partially exploded cutaway side view illustration of a portion of a key lock assembly 920 having features of the present invention that can be included as part of the container assembly 10 (illustrated in FIG. 1A). In particular, FIG. 9A is a partially exploded cutaway view showing a portion of the connector assembly 940, the key lock 970, and a portion of the rotator 931 that can be included as part of the key lock assembly 920. As noted above, the key lock assembly 920 is configured to selectively inhibit relative rotation between the insert retainer assembly 16 (illustrated in FIG. 1B) and the container body 12 (illustrated in FIG. 1A). It is noted that the upper mount 954 is not illustrated in FIG. 9A for purposes of clarity, i.e. so that the engagement between the key lock 970 and the portion of the connector assembly 940 is clearly visible, but can also be an important component for proper and desired functionality of the key lock assembly 970.

The design of the key lock assembly 920 can be varied. In the embodiment illustrated in FIG. 9A, the key lock assembly 920 can include a portion of the connector assembly 940, such as a proximal end 940P of the connector assembly 940, that is configured to extend through the upper mount 554 (illustrated in FIG. 5B) of the mount assembly 550 (illustrated in FIG. 5B), a key lock 970, and a portion of the rotator 931. Alternatively, the key lock assembly 920 can include more components or fewer components than those illustrated and described herein. For example, it is appreciated that, in certain embodiments, the key lock assembly 920 can be configured to fully operate as intended without the inclusion of the rotator 931. In certain other embodiments, the key lock assembly 920 can operate, at least in part, without specific use of the key lock 970, and with the rotator 931 performing and/or enabling certain functions that are typically performed and/or enabled through use of the key lock 970. Thus, for such embodiments, the rotator 931 can sometimes alternatively be referred to as a “keylock”. Additionally, in some implementations, due to the interaction between and/or interrelationship of the key lock 970 and the upper mount 954, the upper mount 954 can also sometimes be considered as forming a part of the key lock assembly 920.

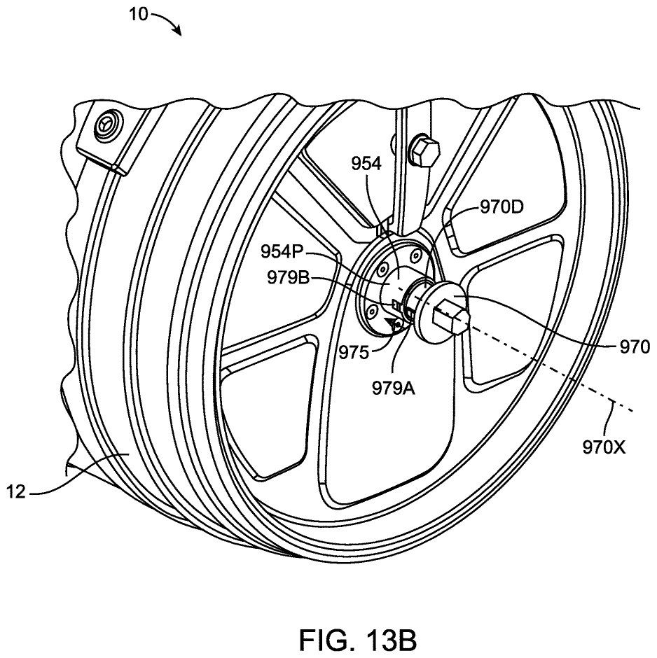

As described in detail herein below, the key lock assembly 920 and/or the key lock 970 is movable between (i) a fully seated configuration 975A (illustrated in FIG. 9A), where the key lock 970 fully engages the proximal end 940P of the connector assembly 940 to selectively inhibit relative rotation between the insert retainer assembly 16 and the container body 12, i.e. so that any rotation of the insert retainer assembly 16, such as through use of the key lock 970 and/or the rotator 931, results in simultaneous and corresponding rotation of the container body 12 (and/or any rotation of the container body 12 (such as when the container body 12 is particularly large so that rollers (not shown) may be used to directly rotate the container body 12) results in simultaneous and corresponding rotation of the insert retainer assembly 16), (ii) a partially seated configuration 975B (illustrated, for example, in FIG. 13A), where the key lock 970 partially engages the proximal end 940P of the connector assembly 940 so that the key lock 970 and/or the rotator 931 can be used to rotate the insert retainer assembly 16, but where relative rotation is permitted between the insert retainer assembly 16 and the container body 12, and (iii) an unseated (or disengaged) configuration 975C (illustrated in FIG. 9B), where the key lock 970 does not engage the proximal end 940P of the connector assembly 940.

As shown in FIG. 9A, the proximal end 940P of the connector assembly 940 includes a portion that is somewhat smaller in cross-sectional size than other portions of the connector assembly 940 to be able to extend through the upper mount 554 of the mount assembly 550, while other portions of the substantially tube-shaped connector assembly 940, including at least the portion of the connector assembly 940 immediately adjacent to the smaller portion of the proximal end 940P of the connector assembly 940, is of a greater cross-sectional size such that it is inhibited from extending through the upper mount 554 of the mount assembly 550. As illustrated, in certain embodiments, the proximal end 940P of the connector assembly 940 can be hollowed out and can include a first attracting component 972A positioned and/or incorporated therein. It is appreciated that the first attracting component 972A can be secured within the hollowed-out portion of the proximal end 940P of the connector assembly 940 in any suitable manner. For example, in one embodiment, the first attracting component 972A can have an epoxy coating to secure the first attracting component 972A in its desired position within the hollowed-out portion of the proximal end 940P of the connector assembly 940. Alternatively, an adhesive can be used to maintain the position of the first attracting component 972A within the hollowed-out portion of the proximal end 940P of the connector assembly 940. Still alternatively, the first attracting component 972A can be secured within the hollowed-out portion of the proximal end 940P of the connector assembly 940 in another suitable manner.

In certain embodiments, as noted above, the proximal end 940P of the connector assembly 940 can be a separate component that is selectively secured to the remainder of the connector assembly 940. With such design, it can be easier to position and/or secure the first attracting component 972A within the hollowed-out portion of the proximal end 940P of the connector assembly 940 prior to selectively securing the proximal end 940P to the remainder of the connector assembly 940. Alternatively, the connector assembly 940, including the proximal end 940 of the connector assembly 940, can have a unitary design, with the first attracting component 972A being positioned and/or secured within the hollowed-out portion of the proximal end 940P of the connector assembly 940 during the manufacturing process.

The key lock 970 includes a lock distal end 970D and an opposed lock proximal end 970P. In certain embodiments, the lock distal end 970D of the key lock 970 can be hollowed out, and shaped and sized to fit closely about the proximal end 940P of the connector assembly 940. As described in greater detail herein below, the size and shape of the hollowed-out portion of the lock distal end 970D can be uniquely configured such that the lock distal end 970D fits over the proximal end 940P of the connector assembly 940 in only one specific rotational orientation.

Additionally, the lock proximal end 970P of the key lock 970 can be hollowed out and can include a second attracting component 972B positioned and/or incorporated therein. As shown in FIG. 9A, during activation of the key lock assembly 920, the lock distal end 970D of the key lock 970 is moved, e.g., slid, down onto the proximal end 940P of the connector assembly 940 into the fully seated configuration 975A. When in the fully seated configuration 975A, the key lock 970 is thus activated so as to inhibit relative rotation between the insert retainer assembly 16 and the container body 12. With such design, the flavor inserts 18 (illustrated in FIG. 7) that are retained by the insert retainer assembly 16 can be effectively maintained in a desired position in the liquid 13 (illustrated in FIG. 2B) retained within the container body 12, so that the flavor inserts 18 can impart flavor into the liquid 13 in a desired manner. Stated in another manner, the activation of the key lock assembly 920, with the lock distal end 970D of the key lock 970 fully seated onto the proximal end 940P of the connector assembly 940, the insert retainer assembly 16, and, thus, the flavor inserts 18 retained therewith, can be maintained in a constant rotational position relative to the container body 12. It is noted that the container assembly 10 and/or the container body 12 are typically maintained in a substantially horizontal position during the aging process, such as with the bunghole 32 (illustrated in FIG. 1A) facing in a generally upward direction, and the flavor inserts 18 positioned in the lower half of the container body 12 so that the flavor inserts 18 will be positioned in the liquid 13 even if the chamber 12A (illustrated in FIG. 1B) is only half full of the liquid 13 being aged.

Importantly, as noted above, the use of the key lock assembly 920 and/or the key lock 970 to inhibit relative rotation between the insert retainer assembly 16 and the container body 12 can effectively overcome the pull of gravity on the heavier paddle (when included), which would otherwise move to the bottom of the chamber 12A and move one or more of the flavor inserts 18 out of the liquid 13. Thus, the operator can better ensure the desired profiles being generated within the liquid 13 during the aging process. Additionally, as further noted above, by continuously enabling the desired rotational positioning of the connector assembly 540 (illustrated in FIG. 5B) and the insert retainer assembly 16 within the chamber 12A, the operator can also collect any desired samples of the liquid 13 from the bottom of the chamber 12A by extending a suitable sampling device through the sampling aperture 540A (illustrated in FIG. 5B) formed into the connector assembly 540.

Additionally, when the lock distal end 970D of the key lock 970 is positioned down onto the proximal end 940P of the connector assembly 940 into the fully seated configuration 975A, the first attracting component 972A and the second attracting component 972B are magnetically attracted to one another. In this fully seated configuration 975A, the magnetic attraction between the first attracting component 972A and the second attracting component 972B helps to ensure that the key lock 970 stays in the activated and locked position, i.e. the fully seated configuration 975A, even during movement of the container assembly 10.

The first attracting component 972A and the second attracting component 972B can have any suitable design for purposes of mutually attracting one another when the key lock 970 is in the activated and locked position. In one embodiment, the first attracting component 972A can be a piece of ferrous material, and the second attracting component 972B can be a magnet. In another embodiment, the first attracting component 972A can be a magnet, and the second attracting component 972B can be a piece of ferrous material. Alternatively, the first attracting component 972A and/or the second attracting component 972B can have another suitable design.

As described herein, the key lock 970 can be moved partially away from the fully seated configuration 975A to the partially seated configuration 975B (as shown in FIG. 13A), where the key lock 970 is not in the fully seated configuration 975A, but is also not fully disengaged (in the unseated (disengaged) configuration 975C (as shown in FIG. 9B)) from the proximal end 940P of the connector assembly 940. When in the partially seated configuration 975B, relative rotation can be attained between the insert retainer assembly 16 and the container body 12, i.e. for stirring the liquid 13, etc.

As further illustrated in FIG. 9A, the rotator 931 can have a rotator distal end 931D that is hollowed out and is configured to selectively engage the lock proximal end 970P of the key lock 970. More specifically, as shown, the lock proximal end 970P of the key lock 970 can have a cross-sectional shape that matches the cross-sectional shape of the hollowed-out portion of the rotator distal end 931D. As described in greater detail herein below, the size and shape of the hollowed-out portion of the rotator distal end 931D can be uniquely configured such that the rotator distal end 931D fits over the lock proximal end 970P of the key lock 970 in only one specific rotational orientation.

As described herein, it is appreciated that, in some embodiments, the hollowed-out portion of the rotator distal end 931D of the rotator 931 can be substantially similar in design to the hollow-out portion of the lock distal end 970D of the key lock 970. Thus, in such embodiments, the key lock assembly 920 can be used to inhibit relative rotation between the insert retainer assembly 16 and the container body 12 without a specific need for the key lock 970, i.e. with the rotator distal end 931D of the rotator 931 positioned fully down onto the proximal end 940P of the connector assembly 940.

In certain embodiments, the proximal end 940P of the connector assembly 940, the lock proximal end 970P of the key lock 970, and the outward-facing portion of the rotator 931 can each include notations, or indicators, that demonstrate the orientation of the flavor inserts 18 and/or the retainer arms 646A (illustrated in FIG. 1B). More specifically, notations or indicators on the proximal end 940P of the connector assembly 940, the lock proximal end 970P of the key lock 970, and the outward-facing portion of the rotator 931 can indicate the orientation of the retainer arms 646A and the paddle (if included) within the container body 12. It is appreciated that the notations or indicators on the proximal end 940P of the connector assembly 940 will accurately indicate the orientation of the retainer arms 646A and the paddle (if included) within the container body 12 at all times when the insert retainer assembly 16 is positioned within the container body 12. However, it is further appreciated that the notations or indicators on the lock proximal end 970P of the key lock 970, and the outward-facing portion of the rotator 931 will only accurately indicate the orientation of the retainer arms 646A and the paddle (if included) within the container body 12, if the lock distal end 970D of the key lock 970 is fully seated onto the proximal end 940P of the connector assembly 940, and the rotator distal end 931D is positioned in a manner to engage the lock proximal end 970P of the key lock 970, respectively. Embodiments of such notations or indicators will be described in greater detail herein below.

FIG. 9B is an exploded cutaway side view illustration of a portion of the key lock assembly 920 illustrated in FIG. 9A. In particular, FIG. 9B again illustrates a portion of the connector assembly 940, the key lock 970, and the rotator 931, which can cooperate to form at least a portion of the key lock assembly 920, with the components aligned to engage one another but with the components not actually engaged with one another, i.e. the lock distal end 970D of the key lock 970 is not engaged with the proximal end 940P of the connector assembly 940. As such, the key lock 970 is being shown in the unseated (or disengaged) configuration 975C relative to the proximal end 940P of the connector assembly 940. It is noted that the upper mount 954 is not illustrated in FIG. 9B for purposes of clarity, i.e. so that the disengagement (or lack of engagement) between the key lock 970 and the portion of the connector assembly 940 is clearly visible. It is further noted that the first attracting component 972A (illustrated in FIG. 9A) and the second attracting component 972B (illustrated in FIG. 9A) are also not shown in FIG. 9B.

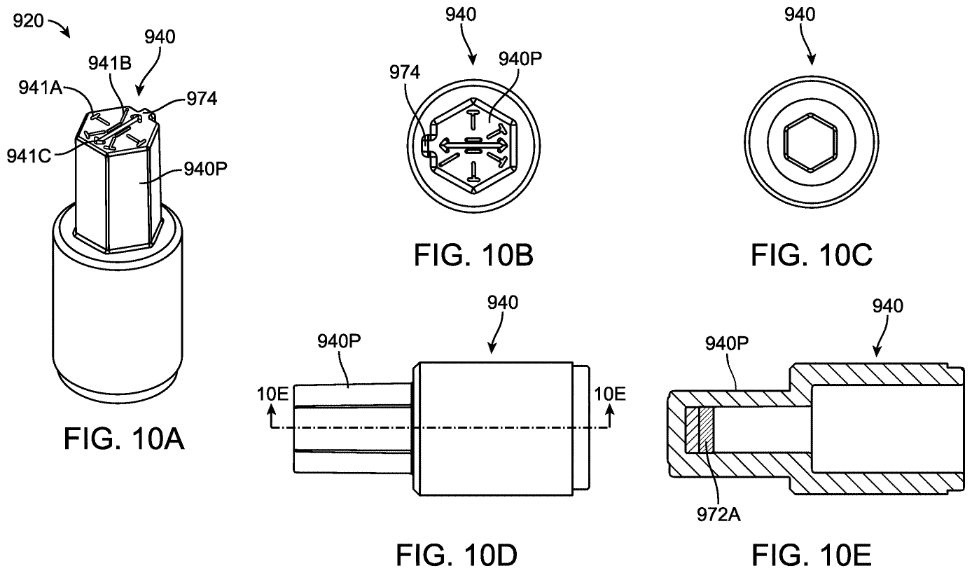

FIG. 10A is a simplified perspective view illustration of an embodiment of a portion of the key lock assembly 920 illustrated in FIG. 9A. In particular, FIG. 10A is a simplified perspective view illustration of a portion of an embodiment of the connector assembly 940 that can be included as part of the key lock assembly 920 illustrated in FIG. 9A.

As illustrated, the connector assembly 940 includes a portion of the proximal end 940P that can be somewhat smaller in cross-sectional size than other portions of the connector assembly 940 to be able to extend through the upper mount 554 (illustrated in FIG. 5B) of the mount assembly 550 (illustrated in FIG. 5B), while other portions of the connector assembly 940 are inhibited from extending through the upper mount 554 of the mount assembly 550. Additionally, as illustrated, in certain embodiments, the proximal end 940P of the connector assembly 940 can have a generally hexagon-shaped cross-section that can correspond with a generally hexagon-shaped, hollowed-out portion of the lock distal end 970D (illustrated in FIG. 9A) of the key lock 970 (illustrated in FIG. 9A). Alternatively, the proximal end 940P of the connector assembly 940 can have another suitable cross-sectional shape that corresponds with the shape of the hollowed-out portion of the lock distal end 970D of the key lock 970. For example, the proximal end 940P of the connector assembly 940 can be generally triangle-shaped, square-shaped, pentagon-shaped, octagon-shaped, oval-shaped, or another suitable shape.

FIG. 10A further illustrates that the proximal end 940P of the connector assembly 940 can include a first engagement feature 974 that is configured to engage a portion of the lock distal end 970D of the key lock 970 so that the lock distal end 970D fits over the proximal end 940P of the connector assembly 940 in only one specific rotational orientation. In one non-exclusive embodiment, the first engagement feature 974 can be a radially outward-facing projection that is configured to engage a portion of the lock distal end 970D of the key lock 970 so that the lock distal end 970D fits over the proximal end 940P of the connector assembly 940 in only one specific rotational orientation. Alternatively, in another embodiment, the first engagement feature 974 can be a radially inward-facing slot that is configured to engage a portion of the lock distal end 970D of the key lock 970 so that the lock distal end 970D fits over the proximal end 940P of the connector assembly 940 in only one specific rotational orientation. Still alternatively, the first engagement feature 974 can have another suitable design.

Also shown in FIG. 10A are a series of notations or indicators that can be displayed on the proximal end 940P of the connector assembly 940 and can effectively indicate the orientation of the retainer arms 646A (illustrated in FIG. 6A), the paddle (if included), and the sampling aperture 540A (illustrated in FIG. 5B). More particularly, as illustrated, the proximal end 940P of the connector assembly 940 can include an arms indicator 941A, a paddle indicator 941B, and a sampling indicator 941C.

The arms indicator 941A is configured to indicate the position and/or orientation of the retainer arms 646A within the container body 12 (illustrated in FIG. 1A). Thus, by using the information available from the arms indicator 941A, the operator can ensure that the retainer arms 646A, and the thus the flavor inserts 18 (illustrated in FIG. 7) are positioned as desired within the liquid 13 (illustrated in FIG. 2B) being aged within the container body 12. Stated differently, with this design, the rotational location of these components can be accurately determined from outside of the container body 12 without seeing these components.

The paddle indicator 941B is configured to indicate the position and/or orientation of the paddle (when included) within the container body 12. Thus, by using the information available from the paddle indicator 941B, the operator can ensure that the paddle is positioned within the liquid 13 at appropriate times to provide the desired stirring of the liquid 13 as the liquid 13 is being aged within the container body 12.

The sampling indicator 941C is configured to indicate the position and/or orientation of the sampling aperture 540D within the container body 12. Thus, by using the information available from the sampling indicator 941A, the operator can ensure that the sampling aperture 540A is positioned as necessary so that samples can be obtained of the liquid 13, from the bottom of the container body 12 when held in the typical horizontal position during the aging process.

The connector assembly 940 can be formed from any suitable materials. For example, in certain embodiments, the connector assembly 940 can be formed from stainless steel or another suitable metallic material. Alternatively, the connector assembly 940 can be made from other suitable materials.

FIG. 10B is a simplified top view illustration of the portion of the connector assembly 940 illustrated in FIG. 10A. In particular, FIG. 10B is a simplified top view illustration showing the general shape, such as a generally hexagon shape in one embodiment, of the proximal end 940P of the connector assembly 940. FIG. 10B further illustrates the first engagement feature 974 being provided in the form of a radially outward-facing projection that is configured to engage a portion of the lock distal end 970D (illustrated in FIG. 9A) of the key lock 970 (illustrated in FIG. 9A) so that the lock distal end 970D fits over the proximal end 940P of the connector assembly 940 in only one specific rotational orientation.

FIG. 10C is a simplified bottom view illustration of the portion of the connector assembly 940 illustrated in FIG. 10A.

FIG. 10D is a simplified side view illustration of the portion of the connector assembly 940 illustrated in FIG. 10A. In particular, FIG. 10D is a simplified side view illustration that shows the proximal end 940P of the connector assembly 940 having a smaller cross-sectional size that extends away from the remainder of the connector assembly 940.

FIG. 10E is a simplified sectional view illustration of the portion of the connector assembly 940 taken on line 10E-10E in FIG. 10D. As illustrated in FIG. 10E, the proximal end 940P of the connector assembly 940 can be hollowed-out and can include the first attracting component 972A positioned and/or incorporated therein.

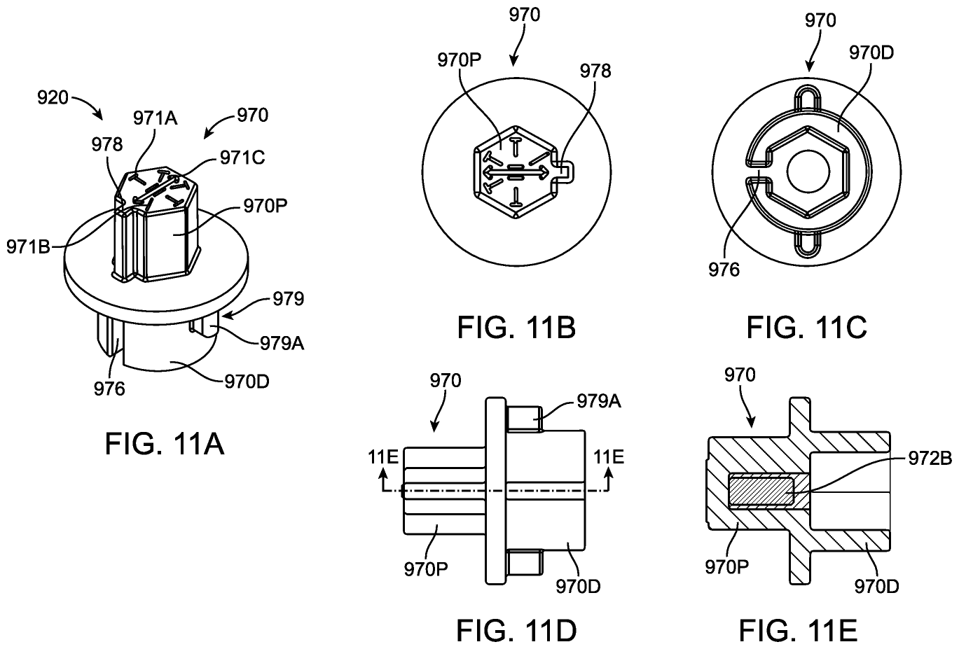

FIG. 11A is a simplified perspective view illustration of an embodiment of another portion of the key lock assembly 920 illustrated in FIG. 9A. In particular, FIG. 11A is a simplified perspective view illustration of an embodiment of the key lock 970 that can be included as part of the key lock assembly 920 illustrated in FIG. 9A. As shown, the key lock 970 includes the lock distal end 970D that is configured to engage the proximal end 940P (illustrated in FIG. 10A) of the connector assembly 940 (illustrated in FIG. 10A), and the lock proximal end 970P that is configured to engage the rotator distal end 931D (illustrated in FIG. 9A) of the rotator 931 (illustrated in FIG. 9A).

As illustrated, in certain embodiments, the lock distal end 970D includes a generally hexagon-shaped, hollowed-out portion that can correspond with the generally hexagon-shaped cross-section of the proximal end 940P of the connector assembly 940. Alternatively, the hollowed-out portion of the lock distal end 970D of the key lock 970 can have another suitable cross-sectional shape that corresponds with the shape of the proximal end 940P of the connector assembly 940. For example, the hollowed-out portion of the lock distal end 970D of the key lock 970 can be generally triangle-shaped, square-shaped, pentagon-shaped, octagon-shaped, oval-shaped, or another suitable shape.

Additionally, as shown in FIG. 11A, the lock distal end 970D of the key lock 970 can include a second engagement feature 976 that is configured to engage the first engagement feature 974 (illustrated in FIG. 10A) formed onto the proximal end 940P of the connector assembly 940 in only one specific rotational orientation. For example, in one non-exclusive embodiment, the second engagement feature 976 can be a radially inward-facing slot that is configured to engage the first engagement feature 974, i.e. in the form of a radially outward-facing projection, formed onto the proximal end 940P of the connector assembly 940 so that the lock distal end 970D fits over the proximal end 940P of the connector assembly 940 in only one specific rotational orientation. Alternatively, in another embodiment, the second engagement feature 976 can be a radially outward-facing projection that is configured to engage the first engagement feature 974, i.e. in the form of a radially inward-facing slot, formed onto the proximal end 940P of the connector assembly 940 so that the lock distal end 970D fits over the proximal end 940P of the connector assembly 940 in only one specific rotational orientation. Still alternatively, the second engagement feature 976 can have another suitable design.

Further, as illustrated, in certain embodiments, the proximal end 970P of the key lock 970 can have a generally hexagon-shaped cross-section that can correspond with a generally hexagon-shaped, hollowed-out portion of the rotator distal end 931D of the rotator 931. Alternatively, the proximal end 970P of the key lock 970 can have another suitable cross-sectional shape that corresponds with the shape of the hollowed-out portion of the rotator distal end 931D of the rotator 931. For example, the proximal end 970P of the key lock 970 can be generally triangle-shaped, square-shaped, pentagon-shaped, octagon-shaped, oval-shaped, or another suitable shape.

Also shown in FIG. 11A is a rotator engager 978 on the lock proximal end 970P of the key lock 970 that is configured to engage a portion of the rotator distal end 931D of the rotator 931 so that the rotator distal end 931D fits over the lock proximal end 970P of the key lock 970 in only one specific rotational orientation. For example, in one non-exclusive embodiment, the rotator engager 978 can be a radially outward-facing projection on the lock proximal end 970P of the key lock 970 that is configured to engage a portion of the rotator distal end 931D of the rotator 931, such as a lock engager in the form of a radially inward-facing slot, so that the rotator distal end 931D fits over the lock proximal end 970P of the key lock 970 in only one specific rotational orientation. Alternatively, in another embodiment, the rotator engager 978 can be a radially inward-facing slot on the lock proximal end 970P of the key lock 970 that is configured to engage a portion of the rotator distal end 931D of the rotator 931, such as a lock engager in the form of a radially outward-facing projection, so that the rotator distal end 931D fits over the lock proximal end 970P of the key lock 970 in only one specific rotational orientation. Still alternatively, the rotator engager 978 and/or the lock engager can have another suitable design.

As described herein, the key lock 970 is movable (e.g., slides) relative to the proximal end 940P of the connector assembly 940 between (i) the fully seated configuration 975A (illustrated in FIG. 9A), where relative rotation is inhibited between the insert retainer assembly 16 (illustrated in FIG. 1B) and the container body 12 (illustrated in FIG. 1A), (ii) the partially seated configuration 975B (illustrated in FIG. 13A), where the key lock 970 is still engaged with the proximal end 940P of the connector assembly 940 but where relative rotation can be obtained between the insert retainer assembly 16 and the container body 12, and (iii) the unseated (or disengaged) configuration 975C (illustrated in FIG. 9B), where the key lock 970 is fully disengaged from the proximal end 940P of the connector assembly 940.

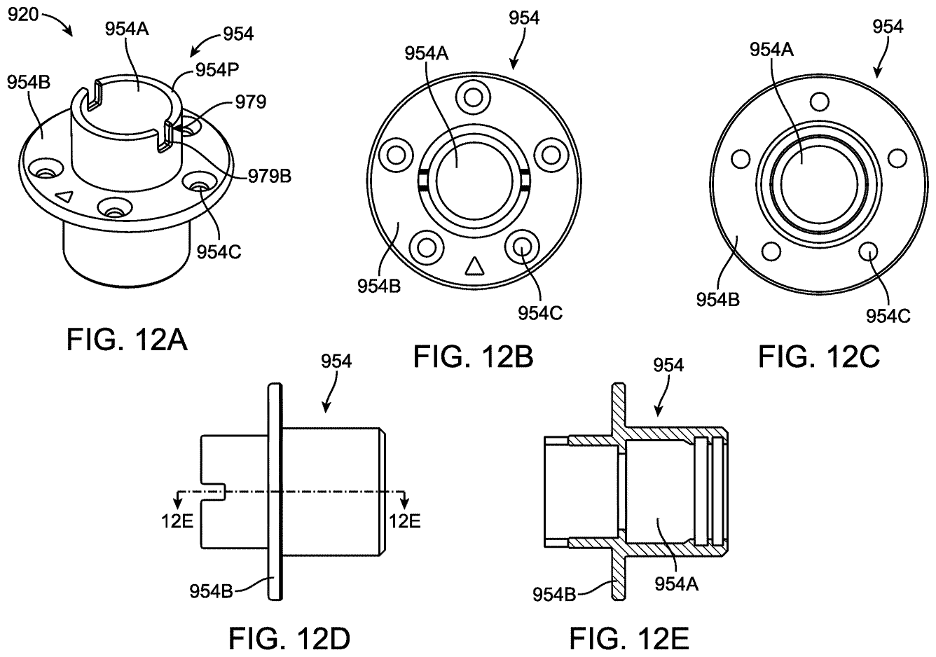

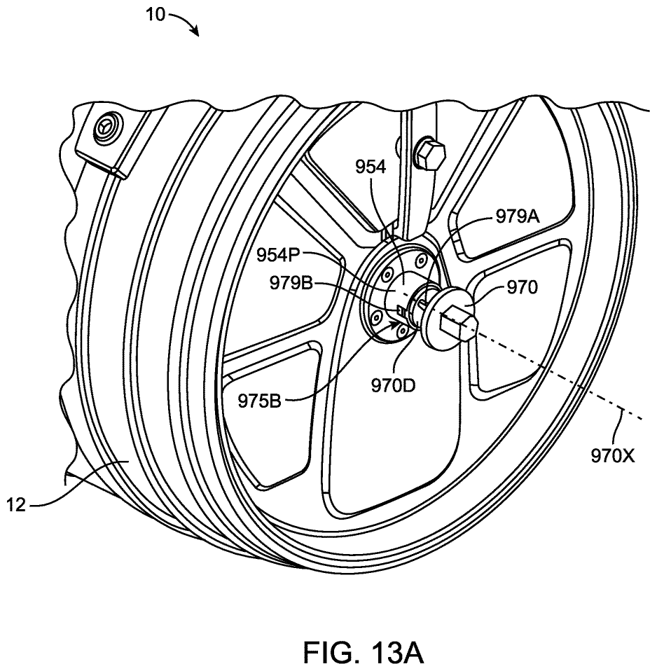

FIG. 11A further illustrates a portion of a seating adjustment system 979 that is configured such that relative rotation between the insert retainer assembly 16 and the container body 12 is inhibited when the key lock 970 is in the fully seated configuration 975A relative to the proximal end 940P of the connector assembly 940, but relative rotation is permitted between the insert retainer assembly 16 and the container body 12 when the key lock 970 is in the partially seated configuration 975B relative to the proximal end 940P of the connector assembly 940. The seating adjustment system 979 can have any suitable design. In certain embodiments, the seating adjustment system 979 includes at least one first seating adjustment member 979A that is coupled to the lock distal end 970D of the key lock 970, and at least one second seating adjustment member 979B (illustrated in FIG. 12A) that is coupled to a mount proximal end 954P (illustrated in FIG. 12A) of the upper mount 954 (illustrated in FIG. 12A). In one non-exclusive embodiment, as more clearly illustrated in FIG. 11D, the seating adjustment system 979 can have two first seating adjustment members 979A (such as rectangular projections in certain non-exclusive embodiments) that are spaced apart approximately 180 degrees from one another about the lock distal end 970D of the key lock 970. With such design, the seating adjustment system 979 more effectively enables the movement between the fully seated configuration 975A and the partially seated configuration 975B, and the different capabilities when the key lock 970 is in the fully seated configuration 975A and the partially seated configuration 975B. More specifically, in this embodiment, the key lock 970 can only be moved (slid) as necessary relative to the upper mount 954 from the partially seated configuration 975B to the fully seated configuration 975A when the first seating adjustment members 979A are aligned with the second seating adjustment members 979B, at two points of rotation of the key lock 970 relative to the upper mount 954 spaced apart by 180 degrees. Alternatively, the seating adjustment system 979 can have more than two first seating adjustment members 979A or only a single first seating adjustment member 979A. Still alternatively, the seating adjustment system 979 can have another suitable design.

In some embodiments, the first seating adjustment members 979A can be provided in the form of projections that extend radially outwardly away from the lock distal end 970D of the key lock 970. As shown in FIG. 11D, the first seating adjustment members 979A can extend approximately half a height of the lock distal end 970D of the key lock 970. With such design, the first seating adjustment members 979A can be configured to effectively engage the second seating adjustment members 979B that are coupled to the mount proximal end 954P of the upper mount 954 when the key lock 970 is in the fully seated configuration 975A relative to the proximal end 940 of the connector assembly 940, but no longer engage the second seating adjustment members 979B that are coupled to the mount proximal end 954P of the upper mount 954 when the key lock 970 is in the partially seated configuration 975B relative to the proximal end 940 of the connector assembly 940. Alternatively, the first seating adjustment members 979A can have another suitable design, such as slots that are formed radially into the lock distal end 970D of the key lock 970.

Also shown in FIG. 11A are a series of notations or indicators that can be displayed on the proximal end 970P of the connector assembly 970 and can effectively indicate the orientation of the retainer arms 646A (illustrated in FIG. 6A), the paddle (if included), and the sampling aperture 540A (illustrated in FIG. 5B). More particularly, as illustrated, the proximal end 970P of the connector assembly 970 can include an arms indicator 971A, a paddle indicator 971B, and a sampling indicator 971C. It is appreciated, however, that the arms indicator 971A, the paddle indicator 971B, and the sampling indicator 971C will only necessarily provide the desired indications when the key lock 970 is in the fully seated configuration 975A relative to the proximal end 940P of the connector assembly 940, and relative rotation between the insert retainer assembly 16 and the container body 12 is effectively inhibited.

The arms indicator 971A is configured to indicate the position and/or orientation of the retainer arms 646A within the container body 12. Thus, by using the information available from the arms indicator 971A, the operator can ensure that the retainer arms 646A, and the thus the flavor inserts 18 (illustrated in FIG. 7) are positioned as desired within the liquid 13 (illustrated in FIG. 2B) being aged within the container body 12. Stated differently, with this design, the rotational location of these components can again be accurately determined from outside of the container body 12 without seeing these components.

The paddle indicator 971B is configured to indicate the position and/or orientation of the paddle (when included) within the container body 12. Thus, by using the information available from the paddle indicator 971B, the operator can ensure that the paddle is positioned within the liquid 13 at appropriate times to provide the desired stirring of the liquid 13 as the liquid 13 is being aged within the container body 12.

The sampling indicator 971C is configured to indicate the position and/or orientation of the sampling aperture 540D within the container body 12. Thus, by using the information available from the sampling indicator 971A, the operator can ensure that the sampling aperture 540A is positioned as necessary so that samples can be obtained of the liquid 13, from the bottom of the container body 12 when held in the typical horizontal position during the aging process.

It is appreciated that similar indicators can be provided on an outward-facing surface of the rotator 931 (illustrated in FIG. 9A). It is further appreciated that such indicators on the outward-facing surface of the rotator 931 will only necessarily provide the desired indications when rotator distal end 931D (illustrated in FIG. 9A) of the rotator 931 fully engages the lock proximal end 970P of the key lock 970, the key lock 970 is in the fully seated configuration 975A relative to the proximal end 940P of the connector assembly 940, and relative rotation between the insert retainer assembly 16 and the container body 12 is effectively inhibited.

The key lock 970 can be formed from any suitable materials. For example, in some embodiments, the key lock 970 can be formed from stainless steel or another suitable metallic material. Alternatively, the key lock 970 can be made from other suitable materials.

FIG. 11B is a simplified top view illustration of the key lock 970 illustrated in FIG. 11A. In particular, FIG. 11B is a simplified top view illustration showing the general shape, such as a generally hexagon shape in one embodiment, of the lock proximal end 970P of the key lock 970. FIG. 11B further illustrates the rotator engager 978 being provided in the form of a radially outward-facing projection that is configured to engage a portion of the rotator distal end 931D (illustrated in FIG. 9A) of the rotator 931 (illustrated in FIG. 9A) so that the rotator distal end 931D fits over the lock proximal end 970P of the key lock 970 in only one specific rotational orientation.

FIG. 11C is a simplified bottom view illustration of the key lock 970 illustrated in FIG. 11A. In particular, FIG. 11C is a simplified bottom view illustration showing the general shape of the hollowed-out portion of the lock distal end 970D of the key lock 970, such as a generally hexagon shape in one embodiment, that is configured to fit over the proximal end 940P (illustrated in FIG. 9A) of the connector assembly 940 (illustrated in FIG. 9A). FIG. 11C further illustrates the second engagement feature 976 being provided in the form of a radially inward-facing slot that is configured to engage a portion of the proximal end 940P of the connector assembly 940 so that the lock distal end 970D of the key lock 970 fits over the proximal end 940P of the connector assembly 940 in only one specific rotational orientation.

FIG. 11D is a simplified side view illustration of the key lock 970 illustrated in FIG. 11A. In particular, FIG. 11D is a simplified side view illustration of the key lock 970 that shows the lock proximal end 970P and the lock distal end 970D of the key lock 970. As noted above, FIG. 11D also illustrates the first seating adjustment members 979A that extend generally radially outwardly away from the lock distal end 970D of the key lock 970 and extend approximately half the height of the lock distal end 970D of the key lock 970. With this design, the movement between the fully seated configuration 975A (illustrated in FIG. 9A) and the partially seated configuration 975B (illustrated in FIG. 13A) is again more effectively enabled in a manner that supports the different capabilities of the fully seated configuration 975A and the partially seated configuration 975B.

FIG. 11E is a simplified sectional view illustration of the key lock 970 taken on line 11E-11E in FIG. 11D. As illustrated in FIG. 11E, the lock proximal end 970P of the key lock 970 can be hollowed out and can include the second attracting component 972B positioned and/or incorporated therein. More specifically, as noted above, when the lock distal end 970D of the key lock 970 is positioned down onto the proximal end 940P (illustrated in FIG. 9A) of the connector assembly 940 (illustrated in FIG. 9A), the first attracting component 972A (illustrated in FIG. 9A) and the second attracting component 972B are magnetically attracted to one another. In this fully seated configuration 975A (illustrated in FIG. 9A), the magnetic attraction between the first attracting component 972A and the second attracting component 972B helps to ensure that the key lock 970 stays in the activated and locked position even during movement of the container assembly 10 (illustrated in FIG. 1A).

FIG. 12A is a simplified perspective view illustration of an embodiment of still another portion of the key lock assembly 920 illustrated in FIG. 9A. More specifically, FIG. 12A is a simplified perspective view illustration of an embodiment of the upper mount 954 that can be included as part of the mount assembly 550 (illustrated in FIG. 5B) and the key lock assembly 920 illustrated in FIG. 9A.

As shown in FIG. 12A, the upper mount 954 can be configured so that the proximal end 940P (illustrated in FIG. 9A) of the connector assembly 940 (illustrated in FIG. 9A) can extend therethrough. In particular, the upper mount 954 can be hollowed out, with a mount aperture 954A extending fully therethrough, and can have suitable size, shape and dimensions that enable the proximal end 940P of the connector assembly 940 to extend at least partially therethrough. Additionally, the upper mount 954 can have an appropriate size and shape so as to not interfere with the desired connection and/or engagement between the proximal end 940P of the connector assembly 940 and the lock distal end 970D (illustrated in FIG. 9A) of the key lock 970 (illustrated in FIG. 9A).

As also illustrated in FIG. 12A, the upper mount 954 can further include a mount flange 954B that extends radially outwardly away from the remainder of the upper mount 954, and is configured to be positioned directly adjacent to the top 26 (illustrated in FIG. 1A) of the container body 12 (illustrated in FIG. 1A) for fixedly securing the upper mount 954 to the container body 12.

A plurality of mount attacher apertures 954C are also shown that extend through the mount flange 954B. Each mount attacher aperture 954C is configured to have a mount attacher (not shown), such as a screw in certain embodiments, extend and/or be threaded therethrough for purposes of fixedly securing the upper mount 954 to the top 26 of the container body 12. The upper mount 954 can be configured to include any suitable number of mount attacher apertures 954C that are each configured to have a mount attacher extend and/or be threaded therethrough. For example, in one non-exclusive embodiment, the upper mount 954 can include five mount attacher apertures 954C that are each configured to have a mount attacher extend and/or be threaded therethrough. Alternatively, the upper mount 954 can include greater than five or less than five mount attacher apertures 954C that are each configured to have a mount attacher extend and/or be threaded therethrough.

FIG. 12A further illustrates another portion of the seating adjustment system 979 that is configured such that relative rotation between the insert retainer assembly 16 (illustrated in FIG. 1B) and the container body 12 (illustrated in FIG. 1A) is inhibited when the key lock 970 is in the fully seated configuration 975A relative to the proximal end 940P of the connector assembly 940, but relative rotation is permitted between the insert retainer assembly 16 and the container body 12 when the key lock 970 is in the partially seated configuration 975B (illustrated in FIG. 13A) relative to the proximal end 940P of the connector assembly 940. In particular, FIG. 12A illustrates an embodiment of the at least one second seating adjustment member 979B that is coupled to the mount proximal end 954P of the upper mount 954, and that is configured to selectively engage the at least one first seating adjustment member 979A (illustrated in FIG. 11A) that is coupled to the lock distal end 970D (illustrated in FIG. 11A) of the key lock 970 (illustrated in FIG. 11A). In one non-exclusive embodiment, the seating adjustment system 979 can have two second seating adjustment members 979B that are spaced apart approximately 180 degrees from one another about the mount proximal end 954P of the upper mount 954. With such design, the seating adjustment system 979 more effectively enables the movement between the fully seated configuration 975A and the partially seated configuration 975B, and the different capabilities when the key lock 970 is in the fully seated configuration 975A and the partially seated configuration 975B. More specifically, in this embodiment, the key lock 970 can only be moved (slid) as necessary relative to the upper mount 954 from the partially seated configuration 975B to the fully seated configuration 975A when the first seating adjustment members 979A are aligned with the second seating adjustment members 979B, at two points of rotation of the key lock 970 relative to the upper mount 954 spaced apart by 180 degrees Alternatively, the seating adjustment system 979 can have more than two second seating adjustment members 979B or only a single second seating adjustment member 979B.

In some embodiments, the second seating adjustment members 979B can be provided in the form of slots that extend radially into the mount proximal end 954P of the upper mount 954. As shown, the second seating adjustment members 979B can extend approximately half a height of the mount proximal end 954P of the upper mount 954. With such design, the second seating adjustment members 979B can be configured to effectively engage the first seating adjustment members 979A that are coupled to the lock distal end 970D of the key lock 970 when the key lock 970 is in the fully seated configuration 975A relative to the proximal end 940 of the connector assembly 940, but no longer engage the first seating adjustment members 979A that are coupled to the lock distal end 970D of the key lock 970 when the key lock 970 is in the partially seated configuration 975B relative to the proximal end 940 of the connector assembly 940. Alternatively, the second seating adjustment members 979B can have another suitable design, such as projections that extend radially outwardly away the mount proximal end 954P of the upper mount 954.

The upper mount 954 can be formed from any suitable materials. For example, in certain embodiments, the upper mount 954 can be formed from stainless steel or another suitable metallic material. Alternatively, the upper mount 954 can be made from other suitable materials.

FIG. 12B is a simplified top view illustration of the upper mount 954 illustrated in FIG. 12A. In particular, FIG. 12B is a simplified top view illustration that shows the mount aperture 954A, the mount flange 954B and the mount attacher apertures 954C that can be included in this embodiment of the upper mount 954.

FIG. 12C is a simplified bottom view illustration of the upper mount 954 illustrated in FIG. 12A. In particular, FIG. 12C is a simplified bottom view illustration that shows the mount aperture 954A, the mount flange 954B and the mount attacher apertures 954C that can be included in this embodiment of the upper mount 954.

FIG. 12D is a simplified side view illustration of the upper mount 954 illustrated in FIG. 12A. In particular, FIG. 12D is a simplified side view illustration that shows the mount flange 954B that can be included in this embodiment of the upper mount 954.

FIG. 12E is a simplified sectional view illustration of the upper mount 954 taken on line 12E-12E in FIG. 12D. In particular, FIG. 12E is a simplified sectional view illustration that shows the mount aperture 954A and the mount flange 954B that can be included in this embodiment of the upper mount 954.

FIG. 13A is a perspective view illustration of a portion of the container assembly 10 illustrated in FIG. 1A, including the key lock 970 and the upper mount 954. In FIG. 13A, the key lock 970 is being shown in the partially seated configuration 975B relative to the mount proximal end 954P of the upper mount 954. More particularly, the lock distal end 970D of the key lock 970 is positioned such that the lock distal end 970D engages the proximal end 940P (illustrated in FIG. 9A) of the connector assembly 940 (illustrated in FIG. 9A), but does not fully engage the mount proximal end 954P of the upper mount 954 in such a manner that the key lock 970 is inhibited from rotating relative to the upper mount 954. Thus, in such position, the key lock 970 and the connector assembly 940, with the insert retainer assembly 16 (illustrated in FIG. 1B) fixedly secured thereto, will rotate together with one another, but the key lock 970 can rotate relative to the upper mount 954 so that relative rotation is permitted between the insert retainer assembly 16 and the container body 12.

Also shown in FIG. 13A are the first seating adjustment member 979A that is coupled to and/or integrally formed into the lock distal end 970D of the key lock 970, and the second seating adjustment member 979B that is coupled to and/or integrally formed into the mount proximal end 954P of the upper mount 954. As illustrated, the lock distal end 970D of the key lock 970 is positioned in the partially seated configuration 975B such that the first seating adjustment member 979A is substantially directly adjacent to the mount proximal end 954P of the upper mount 954. However, the first seating adjustment member 979A is rotationally offset from the second seating adjustment member 979B about a lock axis 970X of the key lock 970. Thus, when the key lock 970 is in this position relative to the upper mount 954, i.e. with the key lock 970 in the partially seated configuration 975B, but with the first seating adjustment member 979A rotationally offset from the second seating adjustment member 979B, the key lock 970 cannot be simply moved (slid) relative to the upper mount 954 and the proximal end 940P of the connector assembly 940 from the partially seated configuration 975B to the fully seated configuration 975A (as shown in FIG. 9A).

FIG. 13B is another perspective view illustration of the portion of the container assembly 10 illustrated in FIG. 13A, again including the key lock 970 and the upper mount 954, and again showing the key lock 970 in the partially seated configuration 975B relative to the mount proximal end 954P of the upper mount 954. Similar to what is shown in FIG. 13A, in FIG. 13B the lock distal end 970D of the key lock 970 is positioned such that the lock distal end 970D engages the proximal end 940P (illustrated in FIG. 9A) of the connector assembly 940 (illustrated in FIG. 9A), but does not fully engage the mount proximal end 954P of the upper mount 954 in such a manner that the key lock 970 is inhibited from rotating relative to the upper mount 954. Thus, in such position, the key lock 970 and the connector assembly 940, with the insert retainer assembly 16 (illustrated in FIG. 1B) fixedly secured thereto, will rotate together with one another, but the key lock 970 can rotate relative to the upper mount 954 so that relative rotation is permitted between the insert retainer assembly 16 and the container body 12.

Also shown in FIG. 13B are the first seating adjustment member 979A that is coupled to and/or integrally formed into the lock distal end 970D of the key lock 970, and the second seating adjustment member 979B that is coupled to and/or integrally formed into the mount proximal end 954P of the upper mount 954. As illustrated, the lock distal end 970D of the key lock 970 is again positioned in the partially seated configuration 975B such that the first seating adjustment member 979A is substantially directly adjacent to the mount proximal end 954P of the upper mount 954. However, as shown in FIG. 13B, the key lock 970 has been rotated about the lock axis 970X relative to the mount proximal end 954P of the upper mount 954 (in comparison to FIG. 13A) so that the first seating adjustment member 979A is now rotationally aligned with the second seating adjustment member 979B. Thus, when the key lock 970 is in this position relative to the upper mount 954, i.e. with the key lock 970 in the partially seated configuration, and with the first seating adjustment member 979A rotationally aligned with the second seating adjustment member 979B, the key lock 970 can be simply moved (slid) along the lock axis 970X (as shown with arrow 975) relative to the upper mount 954 and the proximal end 940P of the connector assembly 940 from the partially seated configuration 975B to the fully seated configuration 975A (as shown in FIG. 9A). When the key lock 970 is then in the fully seated configuration 975A, the first seating adjustment member(s) 979A engage the second seating adjustment member(s) 979B so that relative rotation is inhibited between the key lock 970 and the upper mount 954, and relative rotation is inhibited between the insert retainer assembly 16 and the container body 12.

FIG. 14A is a simplified perspective view illustration of a portion an embodiment of the cover door assembly 1430 having features of the present invention that can be included as part of the container assembly 10 (illustrated in FIG. 1A). In many embodiments, the cover door assembly 1430 is configured to selectively cover and seal the insert opening 28 (illustrated in FIG. 1A) that is formed through the top 1426 (illustrated in FIG. 14C) of the container body 12 (illustrated in FIG. 1A). Additionally, in certain embodiments, as described herein, the cover door assembly 1430 will also include a seal 1429 (illustrated in FIG. 14C) to help seal the insert opening 28 when the cover door assembly 1430 is covering the insert opening 28. However, the seal 1429 is not shown in FIG. 14A for purposes of clarity.

The design of the cover door assembly 1430 can be varied. In certain embodiments, as shown in FIG. 14A, the cover door assembly 1430 can include a cover door 1480, a door support arm 1482, and a door adjustment screw 1484. Alternatively, the cover door assembly 1430 can have a different design, with more components or fewer components than those specifically noted.

The cover door 1480 is sized and shaped to selectively cover and seal the insert opening 28 (from the bottom) that is formed through the top 1426 of the container body 12. More specifically, the cover door 1480 and/or the cover door assembly 1430 is selectively movable relative to the insert opening 28 between (i) a closed configuration, where the cover door 1480 covers and seals the insert opening 28 relative to the remainder of the top 1426 of the container body 12 so that the liquid 13 (illustrated in FIG. 2B) is sealed within the container body 12, and (ii) an open configuration, where the cover door 1480 does not cover and/or seal the insert opening 28 relative to the remainder of the top 1426 of the container body 12. When the cover door 1480 and/or the cover door assembly 1430 is in the closed configuration, the insert opening 28 is closed and sealed and there is no access to the liquid 13 retained within the container body 12 through the insert opening 28. Conversely, when the cover door 1480 and/or the cover door assembly 1430 is in the open configuration, the insert opening 28 is open and access to the liquid 13 within the container body 12 can be gained for any suitable purposes during the aging process.

In the embodiment illustrated in FIG. 14A, the door support arm 1482 is substantially rectangular bar-shaped and is configured to extend over a portion of the cover door 1480. Alternatively, the door support arm 1482 can have another suitable shape and/or can be positioned in another suitable manner.

In certain embodiments, the door adjustment screw 1484 can be a threaded screw that is movably coupled to the door support arm 1482 and the cover door 1480, and is configured to enable the cover door 1480 and/or the cover door assembly 1430 to effectively move between the closed configuration and the open configuration. In particular, the door adjustment screw 1484 can be moved (rotated) relative to the cover door 1480 and/or the door support arm 1482 so that the cover door 1480 and/or the cover door assembly 1430 is selectively movable between the closed configuration and the open configuration.

FIG. 14B is a simplified top view illustration of the cover door assembly 1430 illustrated in FIG. 14A. In particular, FIG. 14B is a simplified top view illustration that again shows the cover door 1480, the door support arm 1482, and the door adjustment screw 1484 that can be included as part of the cover door assembly 1430.

FIG. 14C is a simplified sectional view illustration of the cover door assembly 1430 taken on line 14C-14C in FIG. 14B. FIG. 14C provides another view of the cover door 1480, the door support arm 1482, and the door adjustment screw 1484 that can be included as part of the cover door assembly 1430. Additionally, FIG. 14C also shows a portion of the container body 12, i.e. a portion of the top 1426, being positioned between the cover door 1480 and the door support arm 1482. As shown, the cover door 1480 is configured to be mounted adjacent to the insert opening 28 (illustrated in FIG. 1A) within the chamber 12A (illustrated in FIG. 1B) that is formed within the container body 12 (illustrated in FIG. 1A). FIG. 14C further illustrates a seal 1429 that can be positioned between the top 1426 and the cover door 1480.

Previous cover doors had potential issues of being inadvertently dropped into the liquid within the chamber formed within the container body as the cover door was moved between the closed configuration and the open configuration. The cover door assembly 1430 as described herein is configured to inhibit any such instances from occurring.

As illustrated in the embodiment shown in FIG. 14C, during use of the cover door assembly 1430, the door adjustment screw 1484 is positioned to extend fully through a threaded, arm aperture 1482A that is formed through the door support arm 1482, and then extend at least partially into a threaded, door aperture 1480A that is formed into the cover door 1480. Alternatively, the door adjustment screw 1484 can have another suitable design and/or the door adjustment screw 1484 can be coupled to the cover door 1480 and/or the door support arm 1482 in another suitable manner.

Tightening of the door adjustment screw 1484 relative to the door support arm 1482 and the cover door 1480 moves the cover door 1480 and/or the cover door assembly 1430 toward the closed configuration. More specifically, tightening of the door adjustment screw 1484 pulls the cover door 1480 upwardly toward and against the top 1426 of the container body 12 adjacent to the insert opening 28. When fully tightened, the cover door 1480 and/or the cover door assembly 1430 is in the closed configuration, and the insert opening 28 is fully closed and sealed so that no access can be gained to the liquid 13 retained within the container body 12 through the insert opening 28. As noted, the seal 1429 is further illustrated in FIG. 14C, with the seal 1429 being configured to effectively seal the insert opening 28 when the cover door assembly 1430 is in the closed configuration.

Conversely, as the door adjustment screw 1484 is loosened, the cover door 1480 gradually moves away from the insert opening 28 so that any desired access to the liquid 13 retained within the container body 12 can be gained through the insert opening 28. More particularly, as the door adjustment screw 1484 is loosened, the cover door 1480 moves downward somewhat into the chamber 12A that is formed within the container body 12. As the cover door 1480 thus moves toward the open configuration, the operator can grasp and rotate the door support arm 1482 relative to the cover door 1480, so that the cover door 1480 can be fully moved away from the insert opening 28, such that any desired access to the liquid 13 retained within the container body 12 can be gained through the insert opening 28.

However, to inhibit or prevent the cover door 1480 from inadvertently falling into the container body 12, the door adjustment screw 1484 remains attached to both the door support arm 1482 and the cover door 1480 even when fully loosened such that the cover door 1480 remains coupled to the container body 12 when the cover door 1480 and/or the cover door assembly 1430 is in both the closed configuration and the open configuration. More particularly, as shown in FIG. 14C, the cover door assembly 1430 can further include a disengagement inhibitor 1488, such as a pin in one non-exclusive embodiment, that is coupled to the door adjustment screw 1484 and that inhibits the door adjustment screw 1484 from becoming fully disengaged and/or removed from the door aperture 1480A. It is further appreciated that the use of the door support arm 1482 as a handle can further inhibit the cover door 1480 from inadvertently falling or being dropped into the container body 12.

It is understood that although a number of different embodiments of the container assembly 10 have been illustrated and described herein, one or more features of any one embodiment can be combined with one or more features of one or more of the other embodiments, provided that such combination satisfies the intent of the present invention.

While a number of exemplary aspects and embodiments of the container assembly 10 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A container assembly for retaining a liquid during aging of the liquid, the container assembly being configured to selectively receive and retain a flavor insert that is configured to impart a flavor on the liquid, the container assembly comprising:
a container body that defines a chamber which is configured to receive and retain the liquid;
an insert retainer assembly that is positioned within the chamber, the insert retainer assembly being rotatably coupled to the container body, the insert retainer assembly including an insert retainer that is configured to receive and retain the flavor insert; and
a key lock that is selectively coupled to the insert retainer assembly to inhibit relative rotation between the insert retainer assembly and the container body.

2. The container assembly of claim 1 wherein the insert retainer assembly further includes a connector assembly that rotatably couples the insert retainer assembly to the container body, the connector assembly including a proximal end; and wherein the key lock selectively engages the proximal end of the connector assembly in order to inhibit relative rotation between the insert retainer assembly and the container body.

3. The container assembly of claim 2 wherein the key lock is movable relative to the proximal end of the connector assembly between (i) a fully seated configuration, where the key lock engages the proximal end of the connector assembly to inhibit relative rotation between the insert retainer assembly and the container body, and (ii) a partially seated configuration, where the key lock engages the proximal end of the connector assembly but does not inhibit relative rotation between the insert retainer assembly and the container body.

4. The container assembly of claim 2 wherein the proximal end of the connector assembly includes a first engagement feature that is configured to engage a portion of a lock distal end of the key lock so that the lock distal end fits over the proximal end of the connector assembly in only one specific rotational orientation.

5. (canceled)

6. The container assembly of claim 4 wherein the lock distal end of the key lock includes a second engagement feature that is configured to engage the first engagement feature formed onto the proximal end of the connector assembly so that the lock distal end fits over the proximal end of the connector assembly in the only one specific rotational orientation.

7. The container assembly of claim 6 wherein the first engagement feature is a radially outward-facing projection and the second engagement feature is a radially inward-facing slot that is configured to engage the radially outward-facing projection formed onto the proximal end of the connector assembly so that the lock distal end fits over the proximal end of the connector assembly in the only one specific rotational orientation.

8. The container assembly of claim 2 further comprising a rotator that is selectively coupled to the key lock, the rotator including a rotator distal end; and wherein a lock proximal end of the key lock includes a rotator engager that is configured to engage a portion of the rotator distal end of the rotator so that the rotator distal end fits over the lock proximal end of the key lock in only one specific rotational orientation.

9. The container assembly of claim 8 wherein the rotator engager is a radially outward-facing projection on the lock proximal end of the key lock that is configured to engage a portion of the rotator distal end of the rotator so that the rotator distal end fits over the lock proximal end of the key lock in the only one specific rotational orientation.

10. The container assembly of claim 2 further comprising an upper mount that is fixedly coupled to the container body, the upper mount including a mount aperture and a mount proximal end that extends outwardly away from the container body; wherein the proximal end of the connector assembly is configured to extend at least partially through the mount aperture; and wherein the key lock is movable between (i) a fully seated configuration, where the key lock engages the proximal end of the connector assembly and further engages the mount proximal end of the upper mount, so that the key lock and the insert retainer assembly rotate together with one another, and where relative rotation is inhibited between the insert retainer assembly and the container body, (ii) a partially seated configuration, where the key lock engages the proximal end of the connector assembly, but does not engage the mount proximal end of the upper mount, so that the key lock and the insert retainer assembly rotate together with one another, but where relative rotation is permitted between the insert retainer assembly and the container body, and (iii) an unseated configuration, where the key lock does not engage the proximal end of the connector assembly and does not engage the mount proximal end of the upper mount.

11. (canceled)

12. (canceled)

13. The container assembly of claim 10 further comprising a seating adjustment system including (i) a first seating adjustment member that is coupled to a lock distal end of the key lock, the first seating adjustment member including a radially outward-facing projection that is coupled to the lock distal end of the key lock, and (ii) a second seating adjustment member that is coupled to the mount proximal end of the upper mount, the second seating adjustment member including a slot that is formed into the mount proximal end of the upper mount; wherein the first seating adjustment member engages the second seating adjustment member when the key lock is in the fully seated configuration; and wherein the first seating adjustment member does not engage the second seating adjustment member when the key lock is in the partially seated configuration.

14. (canceled)

15. The container assembly of claim 13 wherein the seating adjustment system includes (i) two first seating adjustment members that are coupled to the lock distal end of the key lock, the two first seating adjustment members being spaced apart approximately 180 degrees from one another about the lock distal end of the key lock, and (ii) two second seating adjustment members that are coupled to the mount proximal end of the upper mount, the two second seating adjustment members being spaced apart approximately 180 degrees from one another about the mount proximal end of the upper mount.

16-22. (canceled)

23. The container assembly of claim 1 wherein the insert retainer assembly further includes a retainer base, the insert retainer being coupled to the retainer base, the insert retainer including at least a first engagement region that is positioned at a first height relative to the retainer base, and a second engagement region that is positioned at a second height relative to the retainer base that is different than the first height; wherein the insert retainer is configured to receive and retain a distal end of a first flavor insert substantially adjacent to the first engagement region, the first flavor insert being configured to impart a first flavor on the liquid; and wherein the insert retainer is configured to receive and retain a distal end of a second flavor insert substantially adjacent to the second engagement region, the second flavor insert being configured to impart a second flavor on the liquid.

24. (canceled)

25. The container assembly of claim 23 wherein the insert retainer includes a first retainer member and a second retainer member that are both coupled to the retainer base, the retainer members being spaced apart from one another to define the first engagement region and the second engagement region.

26. (canceled)

27. (canceled)

28. The container assembly of claim 25 wherein the first retainer member and the second retainer member are flexibly coupled to the retainer base; wherein the insert retainer moves to a first deflected position relative to the retainer base when the insert retainer receives and retains the distal end of the first flavor insert substantially adjacent to the first engagement region, the first engagement region defining a first deflected spacing that is equal to a first thickness of the first flavor insert when the insert retainer receives and retains the distal end of the first flavor insert substantially adjacent to the first engagement region; and wherein the insert retainer moves to a second deflected position relative to the retainer base when the insert retainer receives and retains the distal end of the second flavor insert substantially adjacent to the second engagement region, the second engagement region defining a second deflected spacing that is equal to a second thickness of the second flavor insert when the insert retainer receives and retains the distal end of the second flavor insert substantially adjacent to the second engagement region.

29-32. (canceled)

33. The container assembly of claim 28 wherein the insert retainer further includes a third engagement region that is positioned at a third height relative to the retainer base that is different than the first height and the second height; and wherein the insert retainer is configured to receive and retain a distal end of a third flavor insert substantially adjacent to the third engagement region, the third flavor insert being configured to impart a third flavor on the liquid, the third flavor insert having a third insert thickness that is different than the first thickness and the second thickness.

34-102. (canceled)

103. A method for retaining a liquid during aging of the liquid, the method comprising steps of:
receiving and retaining the liquid with a container body that defines a chamber;
positioning an insert retainer assembly within the chamber, the insert retainer assembly including an insert retainer;
receiving and retaining a flavor insert with the insert retainer, the flavor insert being configured to impart a flavor on the liquid;
rotatably coupling the insert retainer assembly to the container body; and
selectively coupling a key lock to the insert retainer assembly to inhibit relative rotation between the insert retainer assembly and the container body.

104. The method of claim 103 wherein the step of rotatably coupling includes rotatably coupling the insert retainer assembly to the container body with a connector assembly, the connector assembly including a proximal end; and wherein the step of selectively coupling includes selectively engaging the proximal end of the connector assembly with the key lock in order to inhibit relative rotation between the insert retainer assembly and the container body, the key lock including a lock distal end, the proximal end of the connector assembly including a first engagement feature and the lock distal end including a second engagement feature that is configured to engage the first engagement feature of the connector assembly so that the lock distal end fits over the proximal end of the connector assembly in only one specific rotational orientation.

105. The method of claim 104 further comprising a step of selectively coupling a rotator to the key lock, the rotator including a rotator distal end, the key lock including a lock proximal end having a rotator engager including a radially outward-facing projection that is configured to engage a portion of the rotator distal end of the rotator so that the rotator distal end fits over the lock proximal end in only one specific rotational orientation.

106. The method of claim 103 wherein the step of positioning includes the insert retainer assembly further including a retainer base, the insert retainer being coupled to the retainer base, the insert retainer including at least a first engagement region that is positioned at a first height relative to the retainer base, and a second engagement region that is positioned at a second height relative to the retainer base that is different than the first height; and wherein the step of receiving and retaining the flavor insert includes the insert retainer receiving and retaining a distal end of a first flavor insert substantially adjacent to the first engagement region, the first flavor insert being configured to impart a first flavor on the liquid; and the insert retainer receiving and retaining a distal end of a second flavor insert substantially adjacent to the second engagement region, the second flavor insert being configured to impart a second flavor on the liquid.

107. A container assembly for retaining a liquid during aging of the liquid, the container assembly being configured to selectively receive and retain a flavor insert that is configured to impart a flavor on the liquid, the container assembly comprising:
a container body that defines a chamber which is configured to receive and retain the liquid;
an upper mount that is fixedly coupled to the container body, the upper mount including a mount aperture and a mount proximal end that extends outwardly away from the container body;
an insert retainer assembly that is positioned within the chamber, the insert retainer assembly including a connector assembly that rotatably couples the insert retainer assembly to the container body, the connector assembly including a proximal end that is configured to extend at least partially through the mount aperture, the insert retainer assembly including an insert retainer that is configured to receive and retain the flavor insert;
a key lock that selectively engages the proximal end of the connector assembly of the insert retainer assembly to inhibit relative rotation between the insert retainer assembly and the container body; and
a rotator that is selectively coupled to the key lock, the rotator including a rotator distal end;
wherein the proximal end of the connector assembly includes a first engagement feature and a lock distal end of the key lock includes a second engagement feature that is configured to engage the first engagement feature formed onto the proximal end of the connector assembly so that the lock distal end fits over the proximal end of the connector assembly in only one specific rotational orientation;
wherein a lock proximal end of the key lock includes a rotator engager that is configured to engage a portion of the rotator distal end of the rotator so that the rotator distal end fits over the lock proximal end of the key lock in only one specific rotational orientation; and
wherein the key lock is movable between (i) a fully seated configuration, where the key lock engages the proximal end of the connector assembly and further engages the mount proximal end of the upper mount, so that the key lock and the insert retainer assembly rotate together with one another, and where relative rotation is inhibited between the insert retainer assembly and the container body, (ii) a partially seated configuration, where the key lock engages the proximal end of the connector assembly, but does not engage the mount proximal end of the upper mount, so that the key lock and the insert retainer assembly rotate together with one another, but where relative rotation is permitted between the insert retainer assembly and the container body, and (iii) an unseated configuration, where the key lock does not engage the proximal end of the connector assembly and does not engage the mount proximal end of the upper mount.
